(19) United States
(12) Patent Application Publication
(10) Pub. No.: US 2026/0058913 A1
(43) Pub. Date: Feb. 26, 2026

(54) PDU DISCARD INDICATION IN LAYER-TWO PROCEDURES

(71) Applicant: QUALCOMM Incorporated, San Diego, CA (US)

(72) Inventors: Linhai HE, San Diego, CA (US); Ruiming ZHENG, Beijing (CN); Sitaramanjaneyulu KANAMARLAPUDI, San Diego, CA (US)

(21) Appl. No.: 19/104,066

(22) PCT Filed: Sep. 16, 2022
(86) PCT No.: PCT/CN2022/119222

§ 371 Date: Feb. 14, 2025

(51) Int. Cl. H04L 47/32

(52) U.S. Cl. CPC H04L 47/32

(57) ABSTRACT

A method of wireless communication at a first wireless device is disclosed herein. The method includes communicating a plurality of PDUs associated with a DRB with a second wireless device. The method includes detecting that at least one PDU in the plurality of PDUs associated with the DRB meets at least one discard criteria. The method includes transmitting, for the second wireless device, a discard status report associated with the at least one PDU meeting the at least one discard criteria.

### TECHNICAL FIELD

The present disclosure relates generally to communication systems, and more particularly, to protocol data unit (PDU) discard.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a first wireless device are provided. The apparatus includes a memory and at least one processor coupled to the memory and, based at least in part on information stored in the memory, the at least one processor is configured to: communicate a plurality of protocol data units (PDUs) associated with a data radio bearer (DRB) with a second wireless device; detect that at least one PDU in the plurality of PDUs associated with the DRB meets at least one discard criteria; and transmit, for the second wireless device, a discard status report associated with the at least one PDU meeting the at least one discard criteria.

In an aspect of the disclosure, a method, a computer-readable medium, and an apparatus for wireless communication at a second wireless device are provided. The apparatus includes a memory and at least one processor coupled to the memory and, based at least in part on information stored in the memory, the at least one processor is configured to: communicate a plurality of protocol data units (PDUs) associated with a data radio bearer (DRB) with a first wireless device; receive, from the first wireless device, a discard status report associated with at least one PDU in the plurality of PDUs meeting at least one discard criteria; and update a sliding window of the DRB based on the discard status report.

In an aspect of the disclosure, a method, a computer-readable medium, and an apparatus for wireless communication at a first wireless device are provided. The apparatus includes a memory and at least one processor coupled to the memory and, based at least in part on information stored in the memory, the at least one processor is configured to: communicate a plurality of protocol data units (PDUs) associated with a data radio bearer (DRB) with a second wireless device; receive, from the second wireless device based on an expiration of a packet data convergence protocol (PDCP) discard timer, an indication of a sequence number gap associated with at least one PDU of the plurality of PDUs; and update a sliding window of the DRB based on the sequence number gap.

In an aspect of the disclosure, a method, a computer-readable medium, and an apparatus for wireless communication at a second wireless device are provided. The apparatus includes a memory and at least one processor coupled to the memory and, based at least in part on information stored in the memory, the at least one processor is configured to: communicate a plurality of protocol data units (PDUs) associated with a data radio bearer (DRB) with a first wireless device; detect an expiration of a packet data convergence protocol (PDCP) discard timer associated with at least one PDU of the plurality of PDUs; and transmit, for the first wireless device based on the expiration of the PDCP discard timer, an indication of a sequence number gap associated with the at least one PDU of the plurality of PDUs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of extended reality (XR) traffic.

FIG. 5 is a diagram illustrating an example of generating radio link control (RLC) protocol data units (PDUs) from RLC service data units (SDUs).

FIG. 6 is a diagram illustrating an example of an RLC transmitter discarding a PDU.

FIG. 7 is a diagram illustrating an example of an RLC receiver discarding a PDU.

FIG. 8 is an example discard status report.

FIG. 9 is an example discard status report.

FIG. 10 is an example discard status report.

FIG. 11 is an example discard status report.

FIG. 12 is a diagram illustrating an example discard indication control PDU.

FIG. 13 is a diagram illustrating an example discard indication control PDU.

FIG. 14 is a diagram illustrating example communications between a RLC receiver and an RLC transmitter.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a diagram illustrating an example of a hardware implementation for an example apparatus and/or network entity.

FIG. 24 is a diagram illustrating an example of a hardware implementation for an example network entity.

### DETAILED DESCRIPTION

Various types of events may trigger PDU discards in layer 2 (L2) procedures. For example, if a PDU misses a configured delay budget or a signaled delivery deadline, the PDU may become outdated. If an RLC receiver discards a PDU, but does not notify an RLC transmitter of the discard, the RLC transmitter may not advance a transmitter side automatic repeat request (ARQ) window. This may delay further transmissions by the RLC transmitter. If an RLC transmitter discards a PDU, but does not notify an RLC receiver of the discard, there may be a gap in an RLC PDU sequence number (SN). This may delay advancement of a receiver side ARQ window. Various technologies pertaining to PDU discard are described herein. In an example, a first wireless device communicates a plurality of PDUs associated with a DRB with a second wireless device. The first wireless device detects that at least one PDU in the plurality of PDUs associated with the DRB meets at least one discard criteria. The first wireless device transmits, for the second wireless device, a discard status report associated with the at least one PDU meeting the at least one discard criteria. The second wireless device may update a sliding window based upon the discard status report. Thus, the discard status reports may prevent a stall in transmissions by the second wireless device and hence may lead to increased communications reliability at the first wireless device. In another example, the first wireless device communicates a plurality of PDUs associated with a DRB with a second wireless device. The first wireless device receives, from the second wireless device based on an expiration of a PDCP discard timer, an indication of a sequence number gap associated with at least one PDU of the plurality of PDUs. The first wireless device may update a sliding window of the DRB based on the sequence number gap. Thus, the indication of the sequence number gap may aid the first wireless device in updating the sliding window and may lead to increased communications reliability at the first wireless device.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS (e.g., a gNB), 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

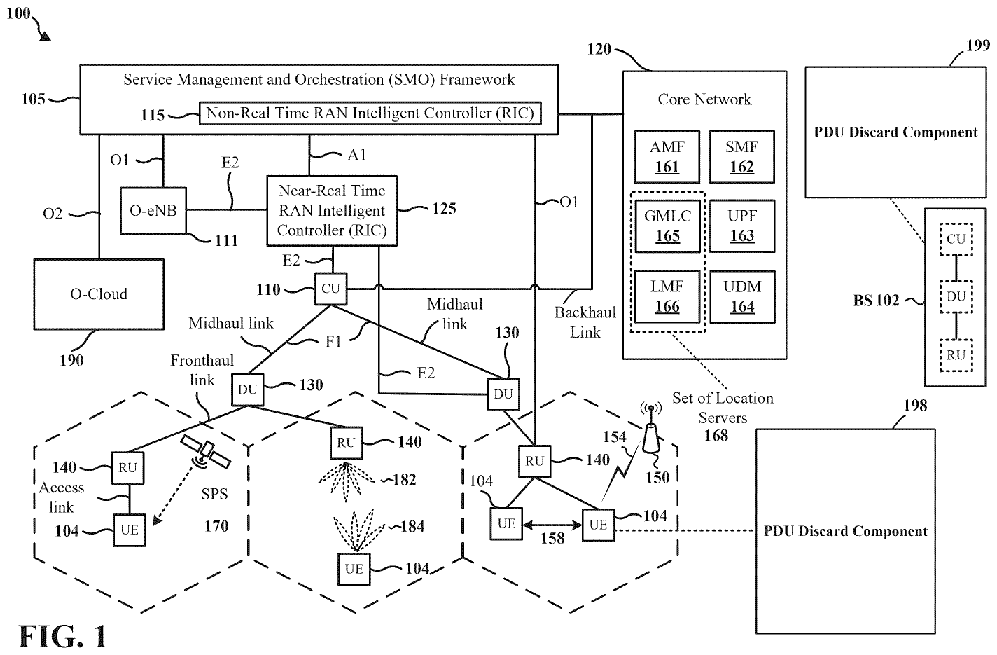

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a PDU discard component 198 that is configured to communicate a plurality of PDUs associated with a DRB with a second wireless device; detect that at least one PDU in the plurality of PDUs associated with the DRB meets at least one discard criteria; and transmit, for the second wireless device, a discard status report associated with the at least one PDU meeting the at least one discard criteria. In certain aspects, the PDU discard component 198 is configured to communicate a plurality of PDUs associated with a DRB with a first wireless device; receive, from the first wireless device, a discard status report associated with at least one PDU in the plurality of PDUs meeting at least one discard criteria; and update a sliding window of the DRB based on the discard status report. In certain aspects, the PDU discard component 198 is configured to communicate a plurality of PDUs associated with a DRB with a second wireless device; receive, from the second wireless device based on an expiration of a PDCP discard timer, an indication of a sequence number gap associated with at least one PDU of the plurality of PDUs; and update a sliding window of the DRB based on the sequence number gap. In certain aspects, the PDU discard component 198 is configured to communicate a plurality of PDUs associated with a DRB with a first wireless device; detect an expiration of a PDCP discard timer associated with at least one PDU of the plurality of PDUs; and transmit, for the first wireless device based on the expiration of the PDCP discard timer, an indication of a sequence number gap associated with the at least one PDU of the plurality of PDUs. In certain aspects, the base station 102 may include a PDU discard component 199 that is configured to XYZ. In certain aspects, the PDU discard component 199 is configured to communicate a plurality of PDUs associated with a DRB with a second wireless device; detect that at least one PDU in the plurality of PDUs associated with the DRB meets at least one discard criteria; and transmit, for the second wireless device, a discard status report associated with the at least one PDU meeting the at least one discard criteria. In certain aspects, the PDU discard component 199 is configured to communicate a plurality of PDUs associated with a DRB with a first wireless device; receive, from the first wireless device, a discard status report associated with at least one PDU in the plurality of PDUs meeting at least one discard criteria; and update a sliding window of the DRB based on the discard status report. In certain aspects, the PDU discard component 199 is configured to communicate a plurality of PDUS associated with a DRB with a second wireless device; receive, from the second wireless device based on an expiration of a PDCP discard timer, an indication of a sequence number gap associated with at least one PDU of the plurality of PDUs; and update a sliding window of the DRB based on the sequence number gap. In certain aspects, the PDU discard component 199 is configured to communicate a plurality of PDUs associated with a DRB with a first wireless device; detect an expiration of a PDCP discard timer associated with at least one PDU of the plurality of PDUs; and transmit, for the first wireless device based on the expiration of the PDCP discard timer, an indication of a sequence number gap associated with the at least one PDU of the plurality of PDUs. Although the following description may be focused on 5G NR, the concepts described herein may be applicable to other similar areas, such as LTE, LTE-A, CDMA, GSM, and other wireless technologies.

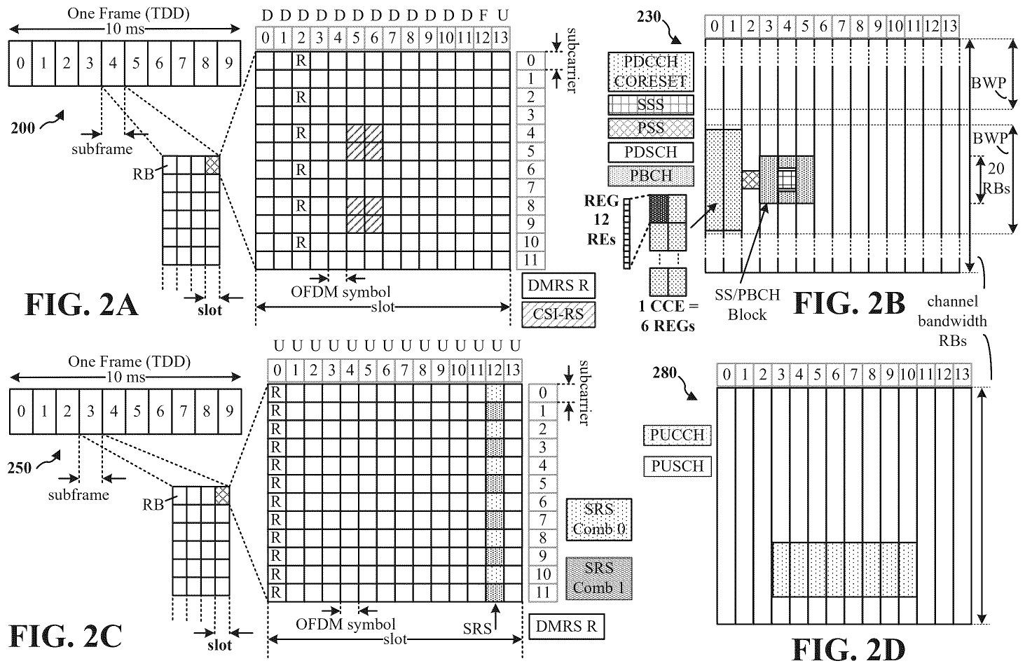

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIG. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIG. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIG. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

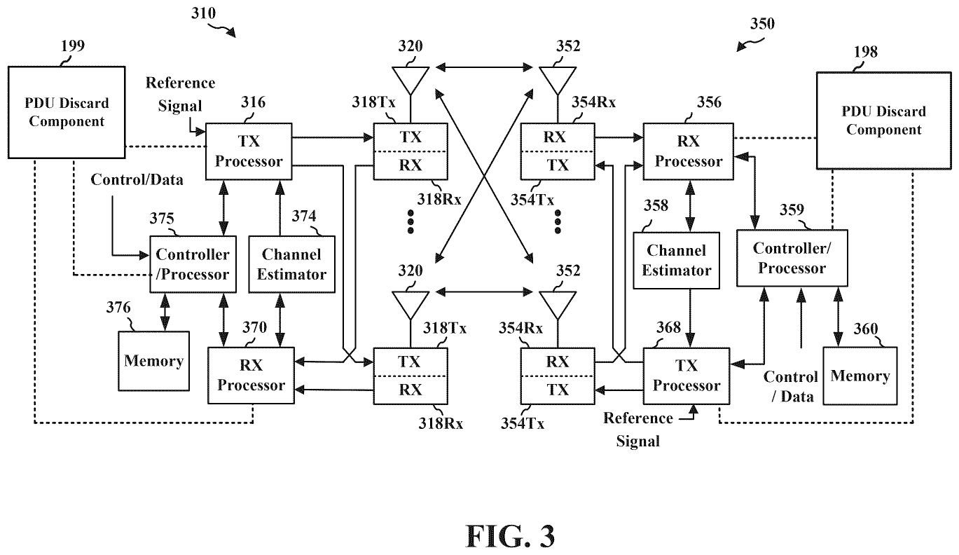

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PDU discard component 198 of FIG. 1.

At least one of the TX processor 316, the RX processor 370, and the controller/processor 375 may be configured to perform aspects in connection with the PDU discard component 199 of FIG. 1.

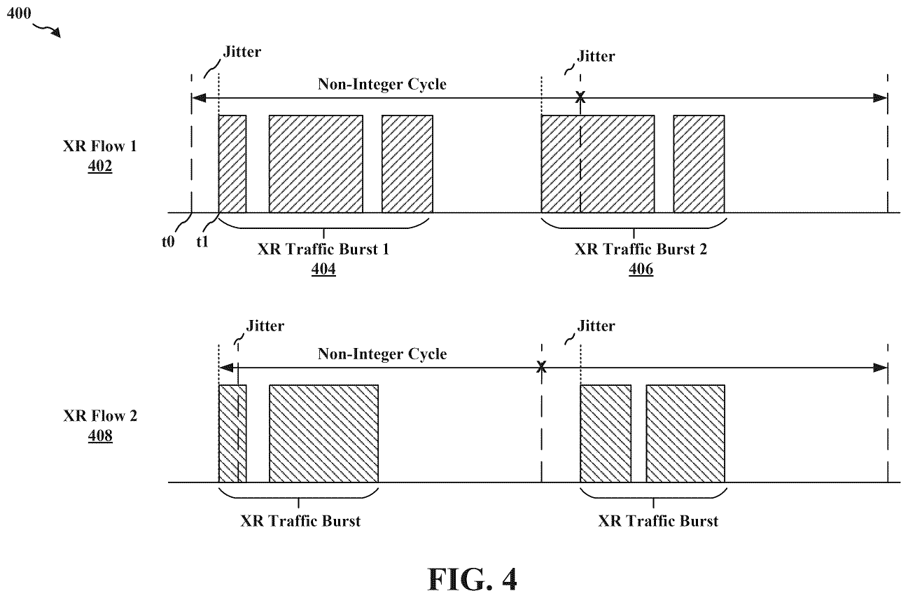

FIG. 4 is a diagram 400 illustrating example XR traffic. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may have several distinguishing characteristics. First, XR traffic may arrive in periodic traffic bursts (“XR traffic bursts”). An XR traffic burst may vary in a number of packets per burst and/or a size of each pack in the burst. The diagram 400 illustrates a first XR flow 402 that may include a first XR traffic burst 404 and a second XR traffic burst 406. As illustrated in the diagram 400, the first XR traffic burst 404 may include three packets (represented as rectangles in the diagram 400) and the second XR traffic burst 406 may include two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

Second, XR traffic bursts may arrive at non-integer periods (i.e., in a non-integer cycle). In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Third, arrival times of XR traffic may vary, that is, XR traffic bursts may arrive at a time that is earlier or later than a time at which a UE (or a base station) expects the XR traffic bursts. This may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time to, but the first packet of the first XR traffic burst 404 arrives at time t1.

Fourth, XR traffic may include multiple flows that may arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

Fifth, XR traffic may follow a packet delay budget (PDB). If a packet does not arrive within the PDB, a UE (or a base station) may discard the packet. In an example, if a packet corresponding to a video frame of a video does not arrive at a UE within a PDB, the UE may discard the packet, as the video has advanced beyond the frame.

In general, XR traffic may be characterized by relatively high data rates and low latency. For instance, XR traffic may have applications in eMBB and URLLC services.

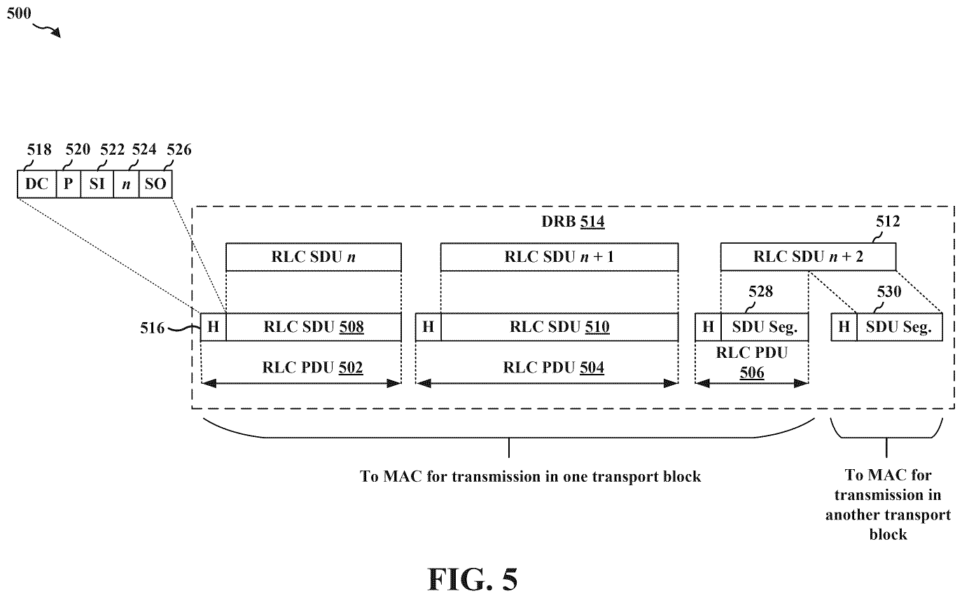

FIG. 5 is a diagram 500 that depicts an example of generating RLC PDUs 502, 504, 506 from RLC SDUs 508, 510, 512. A RLC entity may generate the RLC PDUs 502-506 from the RLC SDUs 508-512. A SDU may refer to a payload within a PDU. In an example, the RLC entity may be a RLC receiver (e.g., the RLC receiver 1402). In another example, the RLC entity may be a RLC transmitter (e.g., the RLC transmitter 1404). As illustrated in the diagram 500, the RLC entity may operate in an acknowledged mode (AM) which may support segmentation, duplicate removal, and retransmission of erroneous data. The RLC PDUs 502-506 may be associated with a data radio bearer (DRB) 514. The DRB 514 may be an AM DRB. The DRB 514 may be a logical transport “pipe” which carries PDUs from a core network and across a RAN to a UE.

The RLC entity may attach a header 516 (illustrated as “H” in the diagram 500) to the RLC SDUs 508-512 (or segments thereof) to generate the RLC PDUs 502-506. A combination of a header and a RLC SDU may be referred to as a RLC PDU. The header 516 may include a data control indicator 518 (illustrated as “DC” in the diagram 500) that may indicate whether an associated RLC PDU contains data to/from a logical channel or control information for RLC operation. The header 516 may include a poll bit 520 (illustrated as “P” in the diagram 500) that may be used to request a status report. The header 516 may include a segmentation information field 522 (illustrated as “SI” in the diagram 500) that indicates whether an associated RLC PDU is a complete RLC SDU, a first segment of an RLC SDU, a last segment of an RLC SDU, or a segment between a first and last segment of the RLC SDU. The header 516 may include a RLC SDU sequence number 524 (illustrated in the diagram 500 as “n”) of an SDU. If the header 516 is associated with a segmented RLC SDU, the header 516 may include a segmentation offset 526 (illustrated in the diagram 500 as “SO”) that indicates which byte of the RLC SDU that the RLC SDU segment represents.

For non-segmented RLC SDUs (e.g., RLC SDU 508 and RLC SDU 510), the RLC entity may attach a header to an associated SDU to generate RLC PDUs (e.g., the RLC PDU 502 and the RLC PDU 504). A size of a last RLC PDU in a transport block may not match a size of a RLC SDU due to MAC multiplexing. As such, the RLC entity may segment an RLC SDU (e.g., the RLC SDU 512) into multiple segments (e.g., SDU segment 528 and SDU segment 530), where each of the multiple segments may include a corresponding header. In an example, the RLC entity may send the RLC PDUs 502-506 to a MAC layer for transport in a first transport block. In the example, the RLC entity may send a RLC PDU associated with the SDU segment 530 to the MAC layer for transport in a second transport block.

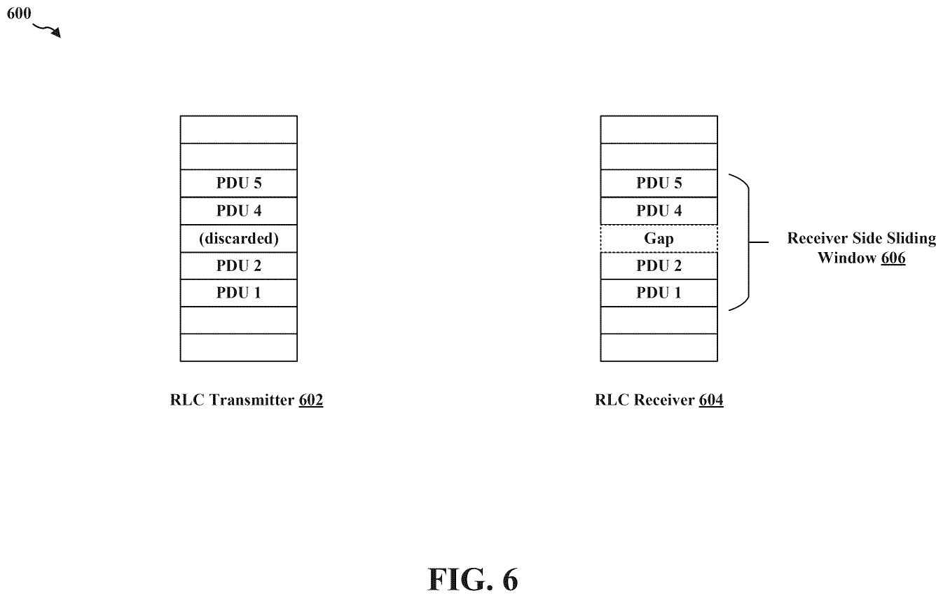

FIG. 6 is a diagram 600 that illustrates an example of an RLC transmitter 602 discarding a PDU. In the example depicted in the diagram 600, the RLC transmitter 602 has discarded a PDU (e.g., a PDU 3). There may be a gap in an RLC SN at the RLC receiver 604 if the RLC transmitter 602 does not notify the RLC receiver 604 of the discarded PDU. The gap may slow advancement of a receiver side sliding window 606 by the RLC receiver 604. For instance, if the RLC transmitter 602 does not notify the RLC receiver 604 of the discarded PDU, the RLC receiver 604 may wait to receive the (discarded) PDU. Waiting to receive the (discarded) PDU may delay the RLC receiver 604 from transmitting an acknowledgment to the RLC transmitter 602, which may delay further transmissions by the RLC transmitter 602.

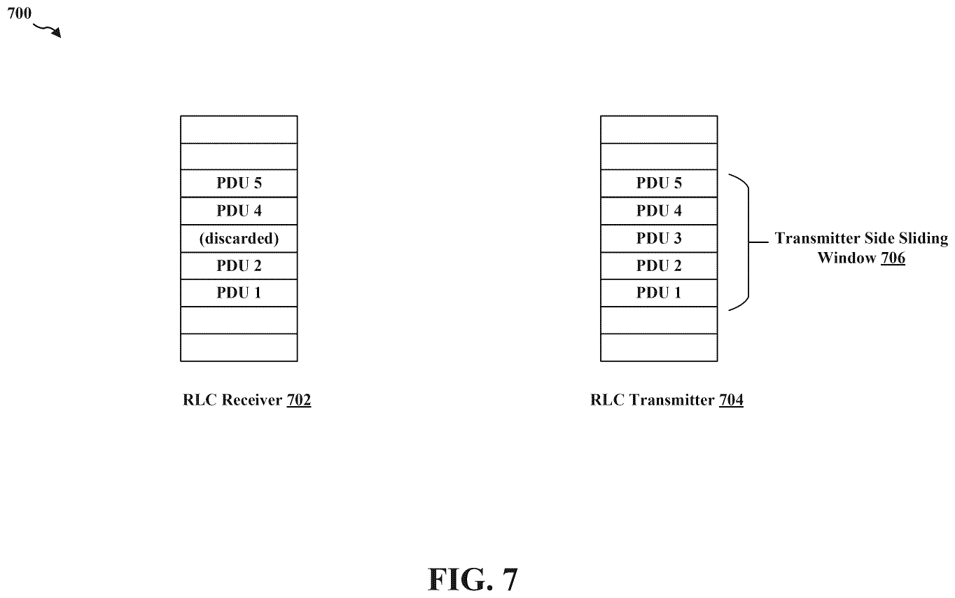

FIG. 7 is a diagram 700 that illustrates an example of an RLC receiver 702 discarding a PDU. A PDU may refer to a data packet transmitted in a 3GPP network. In the example depicted in the diagram 700, a RLC transmitter 704 has transmitted PDUs 1-5. However, the RLC receiver 702 has discarded PDU 3 based upon various criteria (described in greater detail below). If the RLC receiver 702 discards a PDU but does not notify the RLC transmitter 704, the RLC transmitter 704 may not advance a transmitter side sliding window 706. If the RLC transmitter 704 does not advance the transmitter side sliding window 706, further transmissions by the RLC transmitter 704 may be delayed.

Various types of events may trigger PDU discards in L2 procedures. For example, if a PDU misses a configured delay budget or a signaled delivery deadline, the PDU may become outdated. PDU discard may be triggered by intra-PDU set dependency. In one example, a PDU set may be configured such that each PDU in the PDU set is to be transmitted or received. If a PDU in the PDU set is discarded, other PDUs in the PDU set may also be discarded. In another example, if a PDU in the PDU set is discarded, subsequent PDUs in the PDU set may also be discarded. PDU discard may also be triggered by inter-frame dependency (which may be referred to as an inter-PDU set dependency as a frame may include one or multiple PDU sets). In an example, there may be a dependency between PDUs in a quality of service (QoS) flow. For instance, decoding predicted picture frames (p-frames) in a video flow may depend on an intra-coded picture frame (I-frame) in the same burst. If a UE discards the I-frame, the UE may also discard associated P-frames as such frames may be obsolete. If an RLC receiver discards a PDU, but does not notify an RLC transmitter of the discard, the RLC transmitter may not advance a transmitter side ARQ window. This may delay further transmissions by the RLC transmitter. If an RLC transmitter discards a PDU, but does not notify an RLC receiver of the discard, there may be a gap in an RLC PDU SN. This may delay advancement of a receiver side ARQ window.

Various technologies pertaining to PDU discard are described herein. In an example, a first wireless device communicates a plurality of PDUs associated with a DRB with a second wireless device. The first wireless device detects that at least one PDU in the plurality of PDUs associated with the DRB meets at least one discard criteria. The discard criteria may be a set of rules utilized by a UE to determine when/whether a PDU is to be discarded. The first wireless device transmits, for the second wireless device, a discard status report associated with the at least one PDU meeting the at least one discard criteria. The discard status report may include an indication as to which PDUs have been discarded. The second wireless device may update a sliding window based upon the discard status report. Thus, the discard status reports may prevent a stall in transmissions by the second wireless device and hence may lead to increased communications reliability at the first wireless device. In another example, the first wireless device communicates a plurality of PDUs associated with a DRB with a second wireless device. The first wireless device receives, from the second wireless device based on an expiration of a PDCP discard timer, an indication of a sequence number gap associated with at least one PDU of the plurality of PDUs. The first wireless device updates a sliding window of the DRB based on the sequence number gap. Thus, the indication of the sequence number gap may aid the first wireless device in updating the sliding window and may lead to increased communications reliability at the first wireless device.

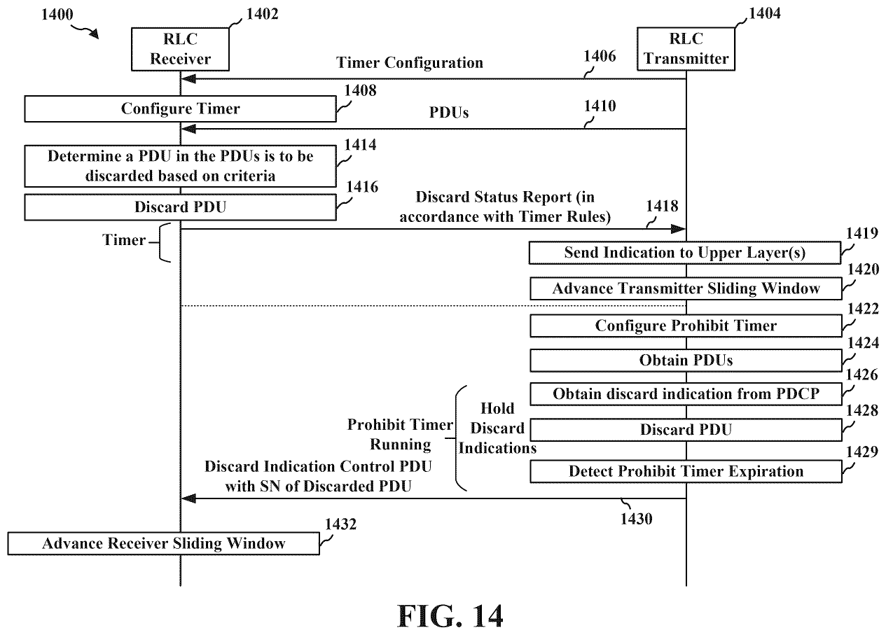

FIG. 14 is a diagram 1400 that depicts communications between a RLC receiver 1402 and a RLC transmitter 1404. In one example, the RLC receiver 1402 may be a UE (e.g., the UE 104, the UE 350, the apparatus 2304, etc.) and the RLC transmitter 1404 may be a base station (e.g., the base station 102, the base station 310, the network entity 2402, etc.). In another example, the RLC receiver 1402 may be a base station (e.g., the base station 102, the base station 310, the network entity 2402, etc.) and the RLC transmitter 1404 may be a UE (e.g., the UE 104, the UE 350, the apparatus 2304, etc.).

In one aspect, the RLC receiver 1402 may discard an RLC PDU. For instance, at 1406, the RLC receiver 1402 may receive a timer configuration transmitted by the RLC transmitter 1404. In one example, the timer configuration may be for configuring a status prohibit timer. The status prohibit timer may be associated with (e.g., triggered by) missing RLC PDUs. When the status prohibit timer is active, the RLC receiver 1402 may not transmit status reports more than once per a time interval determined by the status prohibit timer. In another example, the timer configuration may be for configuring a status report prohibit timer. The status report prohibit timer may be associated with (e.g., triggered by) RLC PDU discards. When the status report prohibit timer is active, the RLC receiver 1402 may not transmit status reports more than once per a time interval determined by the status report prohibit timer. The status prohibit timer and the status report prohibit timer may be associated with different respective time intervals. At 1408, the RLC receiver 1402 may configure a timer based upon the timer configuration received at 1406.

At 1410, the RLC receiver 1402 may receive RLC PDUs transmitted by the RLC transmitter 1404. For instance, the RLC PDUs may be or include the RLC PDUs 502-506 in the diagram 500. In an example, the RLC PDUs may be associated with XR traffic. For instance, the RLC PDUs may be associated with the XR traffic illustrated in the diagram 400. At 1414, the RLC receiver 1402 may determine that a RLC PDU (or more than one RLC PDU) in the RLC PDUs is to be discarded based upon criteria. The criteria may include one or more of an intra-PDU set dependency, a missed delay deadline for receiving the RLC PDU, a flow error correction (FEC) coding redundancy ratio being above a decoding threshold, or an inter-frame dependency. In an example, an intra-PDU set dependency may refer to a PDU missing in a set of PDUs. If the PDU is missing in the set of PDUs (e.g., due to the PDU not being successfully received), the entire set of PDUs may be discarded. In an example, FEC may refer to a class of codes having a unique property: a set of data packets may be coded into N transmitted data packets so that as long as K is less than N packets, the (original) set of data packets can be recovered, where K and N may be integers. The ratio of N to K may be referred to as a redundancy ratio, that is, how much redundancy may be used to protect original data. In an example with respect to intra-frame dependency, a video may be coded by a number of PDUs (or PDU sets). In some encoding schemes, an encoding of a PDU may depend on some frame before the PDU. For example, a second frame in the frame may include a difference (“delta”) from a first PDU in the frame. This may be referred to as an intra-frame dependency. At 1416, the RLC receiver 1402 may discard the RLC PDU based upon the RLC PDU meeting the criteria. For instance, the RLC receiver 1402 may discard RLC SDUs associated with the RLC PDU. In an example in which the RLC PDU 502 is discarded, the RLC receiver 1402 may discard the RLC SDU 508. In another example in which the RLC PDU 506 is discarded, the RLC receiver 1402 may discard the SDU segment 528 and the SDU segment 530.

When the RLC receiver 1402 determines that a RLC PDU or a RLC SDU segment in an AM DRB is to be discarded, the RLC receiver 1402 may trigger transmission of a discard status report to the RLC transmitter 1404. The discard status report may include an indication of a SN of the (discarded) RLC PDU. The RLC receiver 1402 may transmit the discard status report to the RLC transmitter 1404 in accordance with the timer (e.g., the status prohibit timer or the status report prohibit timer) configured at 1408, that is, the RLC receiver 1402 may transmit the discard status report once per a time interval determined by the timer.

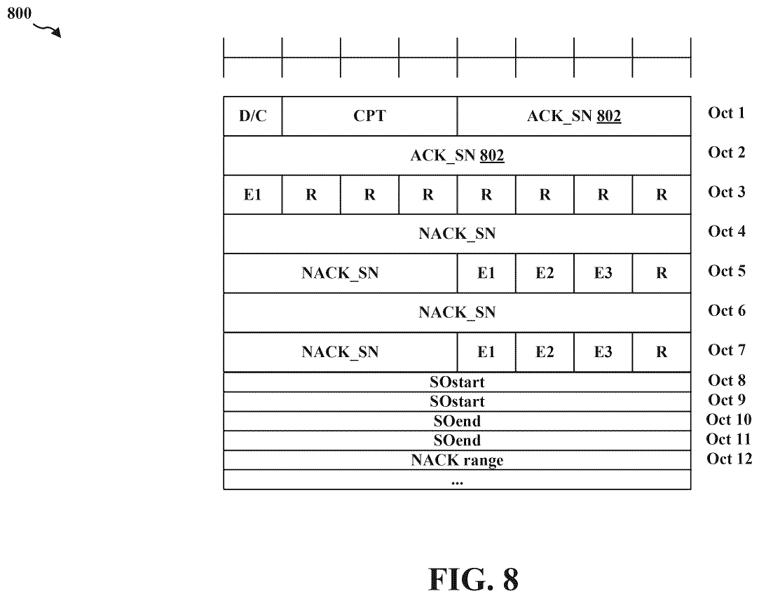

In some aspects, the discard status report transmitted by the RLC receiver 1402 may utilize a format used for missing PDU reporting, that is, the RLC receiver 1402 may repurpose the format to report discarded RLC PDUs. FIG. 8 illustrates an example status report 800 used for missing PDU reporting. The status report 800 may be referred to as a discard status report. The status report 800 may be for an RLC entity configured with a 12-bit SN. The status report 800 may be organized according to octets. In an example, the status report 800 may not include an indication as to whether the status report 800 was triggered by a RLC PDU discard or by reception of a RLC PDU.

The status report 800 may include an indication of whether the status report 800 is for RLC control or RLC data (illustrated as “D/C” in FIG. 8). The status report 800 may include a field (illustrated as “CPT” in FIG. 8) that indicates that the status report relates to status. The status report 800 may include reserved bits (illustrated as “R” in FIG. 8). The status report 800 may include E Fields (illustrated as “E1,” “E2,” and “E3” in FIG. 8) that include information pertaining to whether the status report 800 includes a SN of a RLC PDU that has been detected as lost (illustrated as “NACK_SN” in FIG. 8) and an indication of a portion of a RLC PDU that includes the SN (collectively illustrated by “SOstart” and “SOend” in FIG. 8). The status report may include an indication of lost RLC SDUs (illustrated as “NACK range” in FIG. 8) starting from and including the SN of the RLC PDU that has been detected as lost. The status report 800 may include an ACK_SN 802. The ACK_SN 802 may be a SN of a discarded RLC PDU. In an example, the ACK_SN 802 may be a SN of the RLC PDU discarded by the RLC receiver 1402 at 1416.

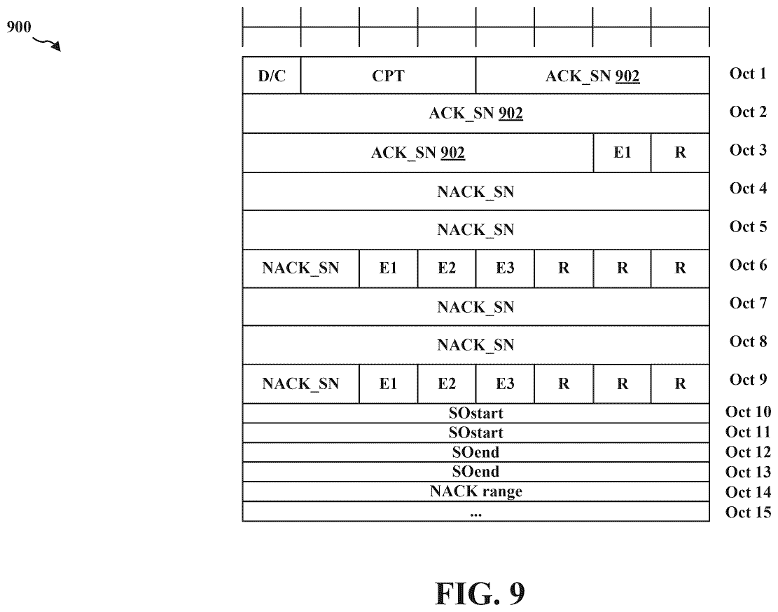

FIG. 9 is a diagram illustrating another example of a status report 900 used for missing RLC PDU reporting, that is, the RLC receiver 1402 may repurpose the format to report discarded RLC PDUs. The status report 900 may be referred to as a discard status report. The status report 900 may be for an RLC entity configured with an 18-bit SN. The ACK_SN 902 in the status report 900 may serve a similar purpose as the ACK_SN 802 in the status report 800 described above, that is, the ACK_SN 902 may be a SN of a discarded RLC PDU. In an example, the ACK_SN 902 may be a SN of the RLC PDU discarded by the RLC receiver 1402 at 1416. The status report 900 may also include “D/C,” “CPT,” “R,” “E1,” “E2,” “E3,” “NACK_SN,” “SOstart,” “SOend,” and “NACK range” as described above in the description of FIG. 8.

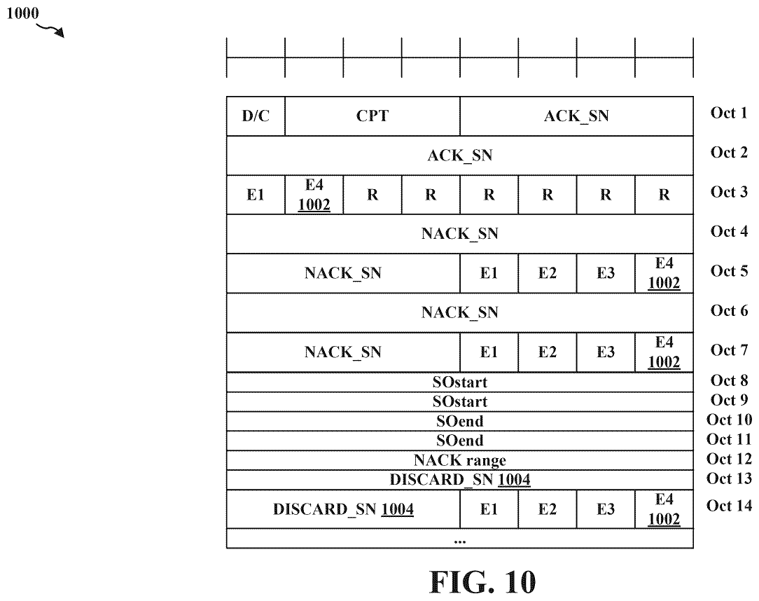

In some aspects, the status report transmitted by the RLC receiver 1402 may utilize a format for RLC PDU discards. FIG. 10 is a diagram illustrating an example of a status report 1000 for RLC PDU discards. The status report 1000 may be referred to as a discard status report. The status report 1000 may be for an RLC entity configured with a 12-bit SN. The status report 1000 may be similar to the status report 800 described above. However, the status report 1000 may include an E4 field 1002 (in place of reserved bits). The E4 field 1002 may include a bit that indicates whether the status report 1000 includes indications of RLC PDU discards. When the E4 field 1002 is set to true, the status report 1000 may include a DISCARD_SN 1004. The DISCARD_SN 1004 may be a SN of a discarded RLC PDU. In an example, the DISCARD_SN 1004 may be a SN of the RLC PDU discarded by the RLC receiver 1402 at 1416. The status report 1000 may also include “D/C,” “CPT,” “R,” “E1,” “E2,” “E3,” “NACK_SN,” “SOstart,” “SOend,” and “NACK range” as described above in the description of FIG. 8. Unlike the status report 800, the status report 1000 may indicate whether the status report 1000 was triggered by RLC PDU discard or by reception of a RLC PDU.

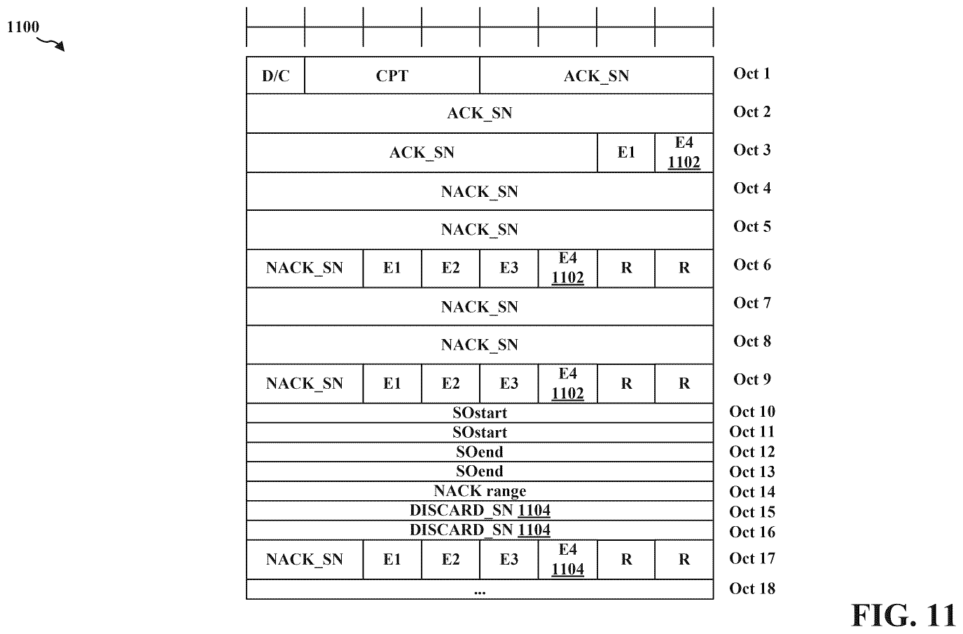

FIG. 11 is a diagram illustrating another example of a status report 1100 for RLC PDU discards. The status report 1100 may be referred to as a discard status report. The status report 1100 may be for an RLC entity configured with an 18-bit SN. The status report 1100 may be similar to the status report 900 described above. However, the status report 1100 may include an E4 field 1102 (in place of reserved bits). The E4 field 1102 may include a bit that indicates whether the status report 1100 includes indications of RLC PDU discards. When the E4 field 1102 is set to true, the status report 1100 may include a DISCARD_SN 1104. The DISCARD_SN 1104 may be a SN of a discarded RLC PDU. In an example, the DISCARD_SN 1104 may be a SN of the RLC PDU discarded by the RLC receiver 1402 at 1416. The status report 1100 may also include “D/C,” “CPT,” “R,” “E1,” “E2,” “E3,” “NACK_SN,” “SOstart,” “SOend,” and “NACK range” as described above in the description of FIG. 8. Unlike the status report 900, the status report 1100 may indicate whether the status report 1100 was triggered by RLC PDU discard or by reception of a RLC PDU.

At 1419, upon receiving the discard status report transmitted at 1418 and if the discard status report is for RLC PDU discards (e.g., the discard status report is based upon the status report 1000 or the status report 1100), the RLC transmitter 1404 may send an indication to one or more upper layers (e.g., a PDCP layer) with respect to the RLC layer indicating that RLC SDU(s) in the discard status report have been discarded by the RLC receiver 1402. At 1420, the RLC transmitter 1404 may advance a transmitter sliding window (e.g., the transmitter side sliding window 706) based on the discard status report transmitted by the RLC receiver 1402 at 1418. In an example, the RLC transmitter 1404 may advance the transmitter sliding window based upon an SN of a discarded RLC PDU included in the discard status report. In an example, the discard status report may be similar or identical to the status report 800, the status report 900, the status report 1000, or the status report 1100 described above. The transmitter sliding window may be a ARQ sliding window.

In an example, the RLC transmitter 1404 may maintain an acknowledgement state variable (“TX_Next_Ack”) which may hold a value of a SN of a next RLC SDU for which a positive acknowledgement is to be received in-sequence. TX_Next_Ack may serve as a lower boundary of the transmitter sliding window. The RLC transmitter 1404 may also maintain a send state variable (“TX_Next”) which may hold a value of a SN that is to be assigned for a next newly generated RLC PDU. In the example, the RLC transmitter 1404 may update the transmitter sliding window as follows. The RLC transmitter 1404 may set TX_Next_Ack to be equal to a SN of an RLC SDU with a smallest SN that falls within a range TX_Next_Ack<=SN<=TX_Next and for which a positive acknowledgement has not yet been received.

In one aspect, the RLC transmitter 1404 may discard an RLC PDU. For instance, referring to FIG. 14, at 1422, the RLC transmitter 1404 may configure a prohibit timer. In an example, the prohibit timer may be a PDCP discard timer. In an example, the RLC transmitter 1404 may configure the prohibit timer based upon a configuration from a network. At 1424, the RLC transmitter 1404 may obtain (e.g., generate, receive, etc.) RLC PDUs. In an example, the RLC PDUs may be associated with the XR traffic illustrated in the diagram 400.

At 1426, the RLC transmitter 1404 may obtain a discard indication from a PDCP layer (or another layer higher than the RLC layer) indicating that a RLC PDU (or RLC PDUs) in the RLC PDUs are to be discarded. Discarding the RLC PDU may cause a gap in SNs of RLC PDUs which have not been acknowledged by the RLC receiver 1402. At 1428, the RLC transmitter 1404 may discard the RLC PDU based upon the discard indication. For instance, the RLC transmitter 1404 may discard RLC SDUs associated with the RLC PDU. In an example in which the RLC PDU 502 is discarded, the RLC transmitter 1404 may discard the RLC SDU 508. In another example in which the RLC PDU 506 is discarded, the RLC transmitter 1404 may discard the SDU segment 528 and the SDU segment 530.

When the RLC transmitter 1404 obtains the discard indication from the PDCP layer at 1426, the prohibit timer (configured at 1422) may begin to run. When the prohibit timer runs, the RLC transmitter 1404 may abstain from transmitting discard indications (e.g., the RLC transmitter 1404 may hold discard indications). At 1429, the RLC transmitter 1404 may detect that the prohibit timer has expired. When the prohibit timer expires, at 1430, the RLC transmitter 1404 may transmit a discard indication control PDU to the RLC receiver 1402. The discard indication control PDU may include a SN of the RLC PDU discarded at 1428.

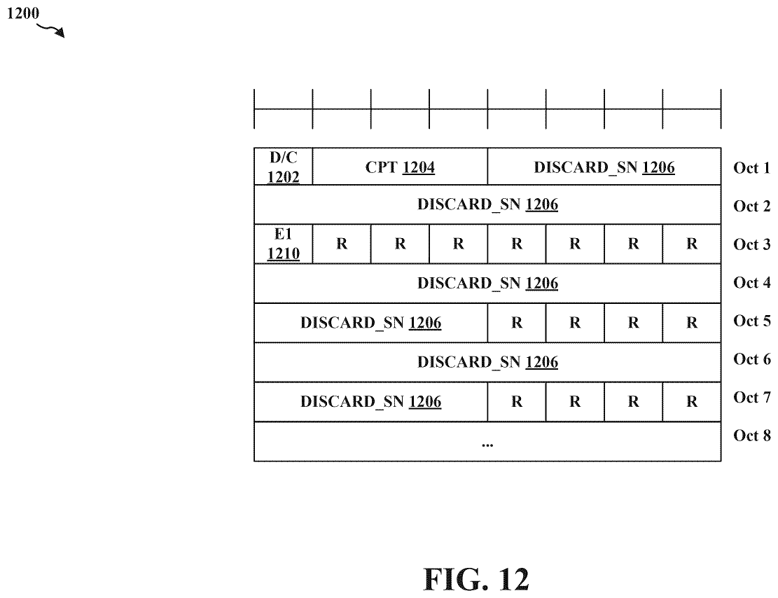

FIG. 12 illustrates an example discard indication control PDU 1200. In an example, the RLC transmitter 1404 may transmit the discard indication control PDU 1200 at 1430 when the prohibit timer expires. The discard indication control PDU 1200 may be configured by an RLC entity configured with a 12-bit SN. The discard indication control PDU 1200 may be organized into octets.

The discard indication control PDU 1200 may include a D/C field 1202 that indicates whether the discard indication control PDU 1200 is for data or control purposes. In an example, the D/C field 1202 may include a “1” bit to indicate that the discard indication control PDU 1200 is a control PDU. The discard indication control PDU 1200 may include a CPT field 1204 that indicates a type of control PDU. In an example, the CPT field 1204 may indicate that the discard indication control PDU 1200 is a discard indication. The discard indication control PDU 1200 may include a DISCARD_SN 1206 that includes a SN of a discarded RLC PDU. The discard indication control PDU 1200 may include an E1 field 1210 that includes a bit that indicates whether additional discard indications follow in the discard indication control PDU 1200. Unlike a status report, the discard indication control PDU 1200 may not include segmentation information, as all segments in a PDU may be discarded when the PDU is to be discarded.

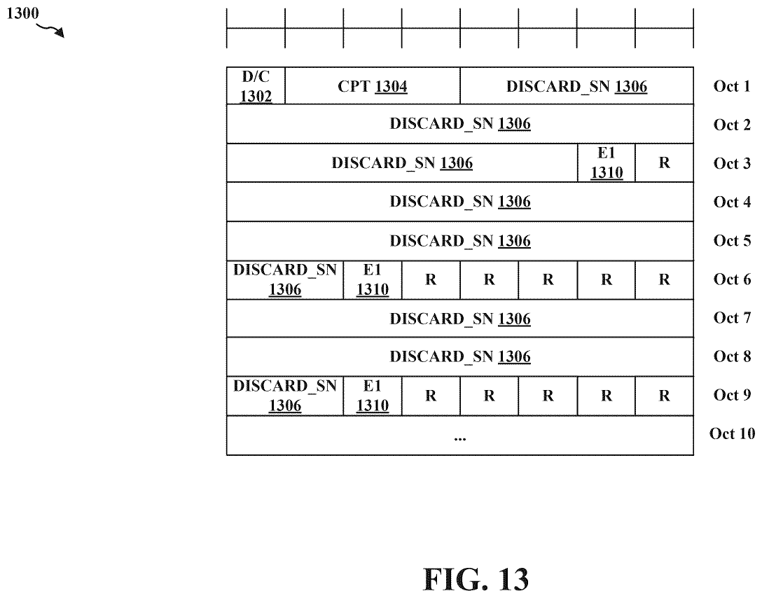

FIG. 13 illustrates an example discard indication control PDU 1300. In an example, the RLC transmitter 1404 may transmit the discard indication control PDU 1300 at 1430 when the prohibit timer expires. The discard indication control PDU 1300 may be configured by an RLC entity configured with an 18-bit SN. The discard indication control PDU 1300 may be organized into octets.

The discard indication control PDU 1300 may include a D/C field 1302 that indicates whether the discard indication control PDU 1300 is for data or control purposes. In an example, the D/C field 1302 may include a “1” bit to indicate that the discard indication control PDU 1300 is a control PDU. The discard indication control PDU 1300 may include a CPT field 1304 that indicates a type of control PDU. In an example, the CPT field 1304 may indicate that the discard indication control PDU 1300 is a discard indication. The discard indication control PDU 1300 may include a DISCARD_SN 1306 that includes a SN of a discarded RLC PDU. The discard indication control PDU 1300 may include an E1 field 1310 that includes a bit that indicates whether additional discard indications follow in the discard indication control PDU 1300. Unlike a status report, the discard indication control PDU 1300 may not include segmentation information, as all segments in a PDU may be discarded when the PDU is to be discarded.

At 1432, the RLC receiver 1402 may advance a receiver sliding window (e.g., the receiver side sliding window 606) based upon the discard indication control PDU. For instance, the RLC receiver 1402 may advance the receiver sliding window based upon the SN of a discarded RLC PDU included in the discard indication control PDU. The receiver sliding window may be a ARQ sliding window.

In an example, the RLC receiver 1402 may maintain a receive state variable (“Rx_Next”) that holds a value of a SN following a last in-sequence fully received RLC SDU. Rx_Next may serve as a lower boundary of the receiver sliding window. The RLC receiver 1402 may also maintain a maximum STATUS transmit state variable (“RX_Highest_Status”) that may hold a highest possible value of a SN that can be indicated by ACK_SN when a STATUS PDU is to be constructed. In the example, the RLC receiver 1402 may update the receiver sliding window as follows. The RLC receiver 1402 may receive a discard indication control PDU for a RLC PDU with SN x, where x is an integer. If x is equal to Rx_Highest_Status, the RLC receiver 1402 may update RX_Highest_Status to have a SN of a first RLC SDU that has a SN that is greater than a current RX_Highest_Status for which all bytes have not been received. If x is equal to RX_Next, the RLC receiver 1402 may update RX_Next to have a SN of a first RLC SDU that has a SN that is greater than a current RX_Next for which all bytes have not been received.

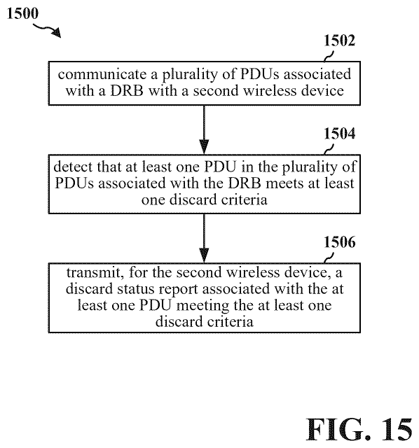

FIG. 15 is a flowchart 1500 of a method of wireless communication at a first wireless device. The method may be performed by a RLC receiver (e.g., the RLC receiver 1402). The RLC receiver may be a UE (e.g., the UE 104, the UE 350, the apparatus 2304). The RLC receiver may be a network entity (e.g., the base station 102, the CU 110, the DU 130, the RU 140, the base station 310, the network entity 2402). In an example, the method may be performed by the PDU discard component 198 or the PDU discard component 199. The method be associated with increased communications reliability for a UE and/or a network entity.

At 1502, the first wireless device communicates a plurality of PDUs associated with a DRB with a second wireless device. For example, FIG. 14 at 1410 shows that the RLC receiver 1402 may receive PDUs from the RLC transmitter 1404. In an example, the PDUs may be or include the RLC PDUs 502-506. In another example, the plurality of PDUs may be associated with the DRB 514 illustrated in FIG. 5. For example, 1502 may be performed by the PDU discard component 198 or the PDU discard component 199.

At 1504, the first wireless device detects that at least one PDU in the plurality of PDUs associated with the DRB meets at least one discard criteria. For example, FIG. 14 at 1414 shows that the RLC receiver 1402 may determine that a PDU is to be discarded based on criteria. In another example, the PDU may be one or more of the RLC PDUs 502-506. For example, 1504 may be performed by the PDU discard component 198 or the PDU discard component 199.

At 1506, the first wireless device transmits, for the second wireless device, a discard status report associated with the at least one PDU meeting the at least one discard criteria. For example, FIG. 14 at 1418 shows that the RLC receiver may transmit a discard status report. In an example, the discard status report may be the status report 800, the status report 900, the status report 1000, or the status report 1100 illustrated in FIGS. 8, 9, 10, and 11, respectively. For example, 1506 may be performed by the PDU discard component 198 or the PDU discard component 199.

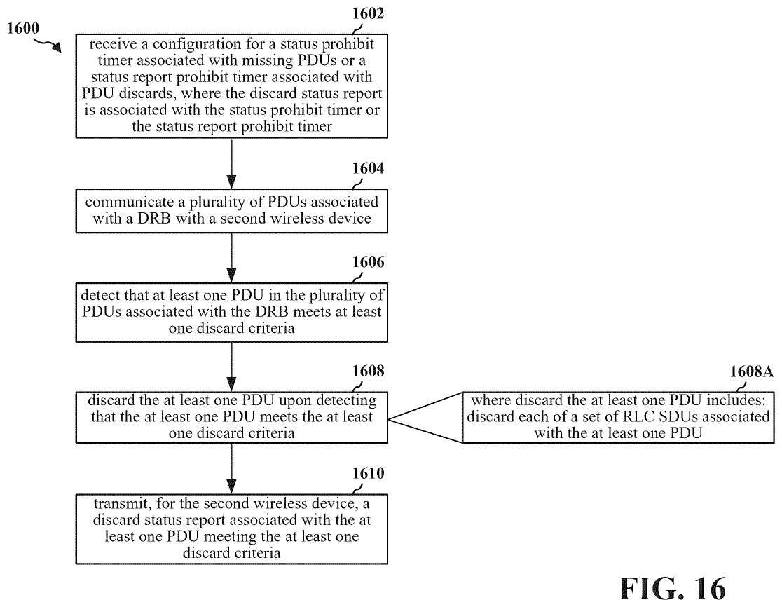

FIG. 16 is a flowchart 1600 of a method of wireless communication at a first wireless device. The method (including the various aspects detailed below) may be performed by a RLC receiver (e.g., the RLC receiver 1402). The RLC receiver may be a UE (e.g., the UE 104, the UE 350, the apparatus 2304). The RLC receiver may be a network entity (e.g., the base station 102, the CU 110, the DU 130, the RU 140, the base station 310, the network entity 2402). In an example, the method (including the various aspects detailed below) may be performed by the PDU discard component 198 or the PDU discard component 199. The method be associated with increased communications reliability for a UE and/or a network entity.

At 1604, the first wireless device communicates a plurality of PDUs associated with a DRB with a second wireless device. For example, FIG. 14 at 1410 shows that the RLC receiver 1402 may receive PDUs from the RLC transmitter 1404. In an example, the PDUs may be or include the RLC PDUs 502-506. In another example, the plurality of PDUs may be associated with the DRB 514 illustrated in FIG. 5. For example, 1604 may be performed by the PDU discard component 198 or the PDU discard component 199.

At 1606, the first wireless device detects that at least one PDU in the plurality of PDUs associated with the DRB meets at least one discard criteria. For example, FIG. 14 at 1414 shows that the RLC receiver 1402 may determine that a PDU is to be discarded based on criteria. In another example, the PDU may be one or more of the RLC PDUs 502-506. For example, 1606 may be performed by the PDU discard component 198 or the PDU discard component 199.

At 1610, the first wireless device transmits, for the second wireless device, a discard status report associated with the at least one PDU meeting the at least one discard criteria. For example, FIG. 14 at 1418 shows that the RLC receiver 1402 may transmit a discard status report. In an example, the discard status report may be the status report 800, the status report 900, the status report 1000, or the status report 1100 illustrated in FIGS. 8, 9, 10, and 11, respectively. For example, 1610 may be performed by the PDU discard component 198 or the PDU discard component 199.

In one aspect, the at least one discard criteria may include one or more of: an intra-PDU set dependency, a missed delay deadline, a FEC coding redundancy ratio being above a decoding threshold, or an inter-frame dependency. For example, the criteria illustrated at 1414 in FIG. 14 may include an intra-PDU set dependency, a missed delay deadline, a FEC coding redundancy ratio being above a decoding threshold, and/or an inter-frame dependency.

In one aspect, at 1608, the first wireless device may discard the at least one PDU upon detecting that the at least one PDU meets the at least one discard criteria. For example, FIG. 14 at 1416 shows that the RLC receiver 1402 may discard a PDU. In an example, the PDU may be one or more of the RLC PDUs 502-506. In another example, FIG. 7 illustrates an RLC receiver 702 discarding a PDU. For example, 1608 may be performed by the PDU discard component 198 or the PDU discard component 199.

In one aspect, at 1608A, discarding the at least one PDU may include discarding each of a set of RLC SDUs associated with the at least one PDU. For example, the set of RLC SDUs may be the RLC SDUs 508-512. For example, 1608A may be performed by the PDU discard component 198 or the PDU discard component 199.

In one aspect, the DRB may be an AM DRB. For example, FIG. 5 illustrates a DRB 514 that may be an AM DRB.

In one aspect, at 1602, the first wireless device may receive a configuration for a status prohibit timer associated with missing PDUs or a status report prohibit timer associated with PDU discards, where the discard status report is associated with the status prohibit timer or the status report prohibit timer. For example, FIG. 14 at 1406 shows that the RLC receiver 1402 may receive a timer configuration. The timer configuration may be associated with a status prohibit timer or a status report prohibit timer. For example, 1602 may be performed by the PDU discard component 198 or the PDU discard component 199.

In one aspect, the discard status report may be transmitted at a time that corresponds to an expiration of the status prohibit timer or the status report prohibit timer. For example, FIG. 14 shows that the RLC receiver 1402 may transmit the discard status report in accordance with timer rules.

In one aspect, the discard status report may utilize an acknowledge field to indicate at least one sequence number of the at least one PDU. For example, the acknowledge field may be the ACK_SN 802 or the ACK_SN 902 illustrated in FIGS. 8 and 9, respectively.

In one aspect, the discard status report may include at least one additional field compared to at least one other discard status report, where the at least one additional field may include at least one sequence number of the at least one PDU. For example, the at least one additional field may include the E4 field 1002 and the DISCARD_SN 1004. The DISCARD_SN 1004 may include the at least one sequence number of the at least one PDU.

In one aspect, the plurality of PDUs may be associated with XR traffic. For example, the plurality of PDUs may be associated with the XR traffic illustrated in FIG. 4.

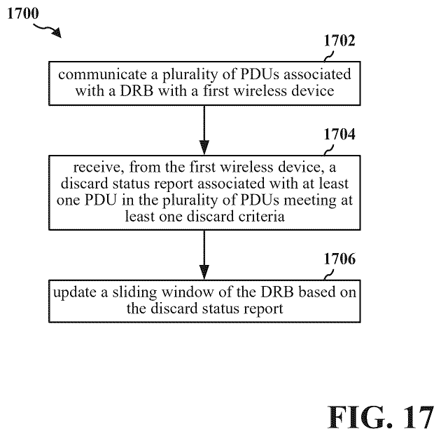

FIG. 17 is a flowchart 1700 of a method of wireless communication at a second wireless device. The method may be performed by a RLC transmitter (e.g., the RLC transmitter 1404). The RLC transmitter may be a UE (e.g., the UE 104, the UE 350, the apparatus 2304). The RLC transmitter may be a network entity (e.g., the base station 102, the CU 110, the DU 130, the RU 140, the base station 310, the network entity 2402). In an example, the method may be performed by the PDU discard component 198 or the PDU discard component 199. The method be associated with increased communications reliability for a UE and/or a network entity.

At 1702, the second wireless device communicates a plurality of PDUs associated with a DRB with a first wireless device. For example, FIG. 14 at 1410 shows that the RLC transmitter 1404 may transmit PDUs to the RLC receiver 1402. In another example, the plurality of PDUs may be the RLC PDUs 502-506 associated with the DRB 514 in FIG. 5. For example, 1702 may be performed by the PDU discard component 198 or the PDU discard component 199.

At 1704, the second wireless device receives, from the first wireless device, a discard status report associated with at least one PDU in the plurality of PDUs meeting at least one discard criteria. For example, FIG. 14 at 1418 shows that the RLC transmitter 1404 may receive a discard status report. In an example, the discard status report may be the status report 800, the status report 900, the status report 1000, or the status report 1100 illustrated in FIGS. 8, 9, 10, and 11, respectively. For example, 1704 may be performed by the PDU discard component 198 or the PDU discard component 199.

At 1706, the second wireless device updates a sliding window of the DRB based on the discard status report. For example, FIG. 14 at 1420 shows that the RLC transmitter 1404 may advance a transmitter sliding window. In another example, the RLC transmitter 704 may advance the transmitter side sliding window 706 illustrated in FIG. 7. For example, 1706 may be performed by the PDU discard component 198 or the PDU discard component 199. Updating the sliding window may avoid stalls in transmissions from the second wireless device to the first wireless device.

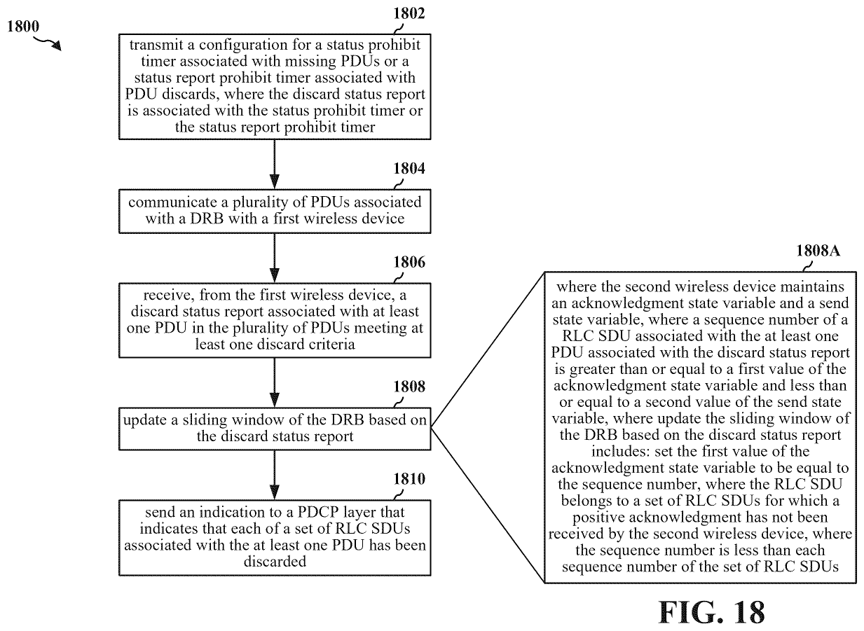

FIG. 18 is a flowchart 1800 of a method of wireless communication at a second wireless device. The method (including the various aspects detailed below) may be performed by a RLC transmitter (e.g., the RLC transmitter 1404). The RLC transmitter may be a UE (e.g., the UE 104, the UE 350, the apparatus 2304). The RLC transmitter may be a network entity (e.g., the base station 102, the CU 110, the DU 130, the RU 140, the base station 310, the network entity 2402). In an example, the method (including the various aspects detailed below) may be performed by the PDU discard component 198 or the PDU discard component 199. The method be associated with increased communications reliability for a UE and/or a network entity.

At 1804, the second wireless device communicates a plurality of PDUs associated with a DRB with a first wireless device. For example, FIG. 14 at 1410 shows that the RLC transmitter 1404 may transmit PDUs to the RLC receiver 1402. In another example, the plurality of PDUs may be the RLC PDUs 502-506 associated with the DRB 514 in FIG. 5. For example, 1804 may be performed by the PDU discard component 198 or the PDU discard component 199.

At 1806, the second wireless device receives, from the first wireless device, a discard status report associated with at least one PDU in the plurality of PDUs meeting at least one discard criteria. For example, FIG. 14 at 1418 shows that the RLC transmitter 1404 may receive a discard status report. In an example, the discard status report may be the status report 800, the status report 900, the status report 1000, or the status report 1100 illustrated in FIGS. 8, 9, 10, and 11, respectively. For example, 1806 may be performed by the PDU discard component 198 or the PDU discard component 199.

At 1808, the second wireless device updates a sliding window of the DRB based on the discard status report. For example, FIG. 14 at 1420 shows that the RLC transmitter 1404 may advance a transmitter sliding window. In another example, the RLC transmitter 704 may advance the transmitter side sliding window 706 illustrated in FIG. 7. For example, 1808 may be performed by the PDU discard component 198 or the PDU discard component 199. Updating the sliding window may avoid stalls in transmissions from the second wireless device to the first wireless device.

In one aspect, the at least one discard criteria may include one or more of: an intra-PDU set dependency, a missed delay deadline, a FEC coding redundancy ratio being above a decoding threshold, or an inter-frame dependency. For example, the criteria illustrated at 1414 in FIG. 14 may include an intra-PDU set dependency, a missed delay deadline, a FEC coding redundancy ratio being above a decoding threshold, and/or an inter-frame dependency.

In one aspect, the DRB may be an AM DRB. For example, FIG. 5 illustrates a DRB 514 that may be an AM DRB.

In one aspect, at 1802, the second wireless device may transmit a configuration for a status prohibit timer associated with missing PDUs or a status report prohibit timer associated with PDU discards, where the discard status report is associated with the status prohibit timer or the status report prohibit timer. For example, FIG. 14 at 1406 shows that the RLC transmitter 1404 may transmit a timer configuration. The timer configuration may be associated with a status prohibit timer or a status report prohibit timer. For example, 1802 may be performed by the PDU discard component 198 or the PDU discard component 199.

In one aspect, the discard status report may be received at a time that corresponds to an expiration of the status prohibit timer or the status report prohibit timer. For example, FIG. 14 shows that the RLC transmitter 1404 may receive the discard status report in accordance with timer rules.

In one aspect, the discard status report may utilize an acknowledge field to indicate at least one sequence number of the at least one PDU. For example, the acknowledge field may be the ACK_SN 802 or the ACK_SN 902 illustrated in FIGS. 8 and 9, respectively.

In one aspect, the discard status report may include at least one additional field compared to at least one other discard status report, where the at least one additional field includes at least one sequence number of the at least one PDU. For example, the at least one additional field may include the E4 field 1002 and the DISCARD_SN 1004. The DISCARD_SN 1004 may include the at least one sequence number of the at least one PDU.

In one aspect, at 1810, the second wireless device may send an indication to a PDCP layer that indicates that each of a set of RLC SDUs associated with the at least one PDU has been discarded. For example, FIG. 14 at 1419 shows that the RLC transmitter 1404 may send an indication to one or more upper layer(s) (e.g., a PDCP layer) indicating that a set of RLC SDUs has been discarded. In an example, the RLC SDUs may be the RLC SDUs 508-512 in FIG. 5. For example, 1810 may be performed by the PDU discard component 198 or the PDU discard component 199.

In one aspect, the plurality of PDUs may be associated with XR traffic. For example, the plurality of PDUs may be associated with the XR traffic illustrated in FIG. 4.

In one aspect, at 1808A, the second wireless device may maintain an acknowledgment state variable and a send state variable, where a sequence number of a RLC SDU associated with the at least one PDU associated with the discard status report is greater than or equal to a first value of the acknowledgment state variable and less than or equal to a second value of the send state variable and updating the sliding window of the DRB based on the discard status report may include: set the first value of the acknowledgment state variable to be equal to the sequence number, where the RLC SDU belongs to a set of RLC SDUs for which a positive acknowledgment has not been received by the second wireless device, where the sequence number is less than each sequence number of the set of RLC SDUs. For example, advancing the transmitter sliding window at illustrated in FIG. 14 at 1420 may include setting a first value of the acknowledgment state variable to be equal to the sequence number as described above. For example, 1808A may be performed by the PDU discard component 198 or the PDU discard component 199.

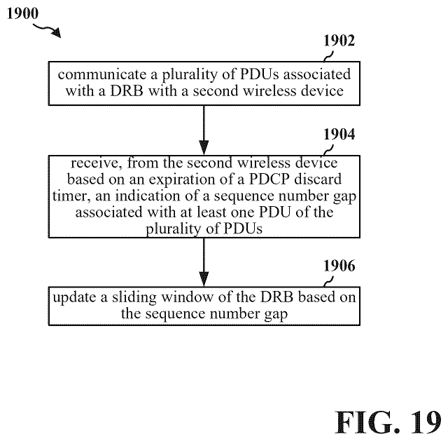

FIG. 19 is a flowchart 1900 of a method of wireless communication at a first wireless device. The method may be performed by a RLC receiver (e.g., the RLC receiver 1402). The RLC receiver may be a UE (e.g., the UE 104, the UE 350, the apparatus 2304). The RLC receiver may be a network entity (e.g., the base station 102, the CU 110, the DU 130, the RU 140, the base station 310, the network entity 2402). In an example, the method may be performed by the PDU discard component 198 or the PDU discard component 199. The method be associated with increased communications reliability for a UE and/or a network entity.

At 1902, the first wireless device communicates a plurality of PDUs associated with a DRB with a second wireless device. For example, FIG. 14 at 1410 shows that the RLC receiver 1402 may receive PDUs from the RLC transmitter 1404. In an example, the PDUs may be the RLC PDUs 502-506 associated with the DRB 514 illustrated in FIG. 5. For example, 1902 may be performed by the PDU discard component 198 or the PDU discard component 199.

At 1904, the first wireless device receives, from the second wireless device based on an expiration of a PDCP discard timer, an indication of a sequence number gap associated with at least one PDU of the plurality of PDUs. For example, FIG. 14 at 1430 shows that the RLC receiver 1402 may receive a discard indication control PDU that includes a SN of a discarded PDU. FIG. 14 also shows that the RLC receiver 1402 may receive the discard indication control PDU based on expiration of a prohibit timer. In an example, the indication of the sequence number gap may be indicated by the DISCARD_SN 1206 of the discard indication control PDU 1200 in FIG. 12 or the DISCARD_SN 1306 of the discard indication control PDU 1300 in FIG. 13. In an example, the at least one PDU may be one of the RLC PDUs 502-506. In yet another example, FIG. 6 illustrates an example of a gap. For example, 1904 may be performed by the PDU discard component 198 or the PDU discard component 199.

At 1906, the first wireless device updates a sliding window of the DRB based on the sequence number gap. For example, FIG. 14 at 1432 shows that the RLC receiver 1402 may advance a receiver sliding window based on the discard indication control PDU. In another example, the RLC receiver 604 in FIG. 6 may update the receiver side sliding window 606. For example, 1906 may be performed by the PDU discard component 198 or the PDU discard component 199. Updating the sliding window may lead to the first wireless device receiving communications in a faster manner, as the first wireless device may not continue to wait to receive a PDU discarded by the second wireless device.

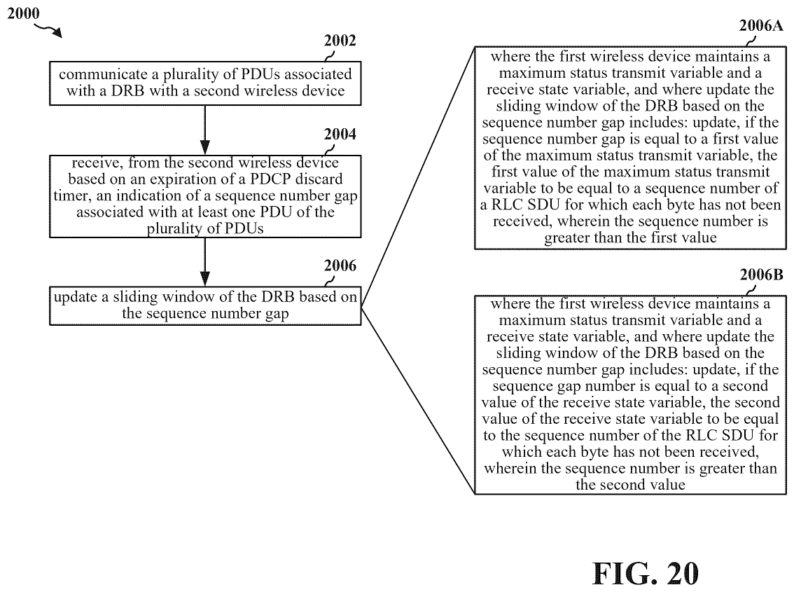

FIG. 20 is a flowchart 2000 of a method of wireless communication at a first wireless device. The method (including the various aspects detailed below) may be performed by a RLC receiver (e.g., the RLC receiver 1402). The RLC receiver may be a UE (e.g., the UE 104, the UE 350, the apparatus 2304). The RLC receiver may be a network entity (e.g., the base station 102, the CU 110, the DU 130, the RU 140, the base station 310, the network entity 2402). In an example, the method (including the various aspects detailed below) may be performed by the PDU discard component 198 or the PDU discard component 199. The method be associated with increased communications reliability for a UE and/or a network entity.

At 2002, the first wireless device communicates a plurality of PDUs associated with a DRB with a second wireless device. For example, FIG. 14 at 1410 shows that the RLC receiver 1402 may receive PDUs from the RLC transmitter 1404. In an example, the PDUs may be the RLC PDUs 502-506 associated with the DRB 514 illustrated in FIG. 5. For example, 2002 may be performed by the PDU discard component 198 or the PDU discard component 199.

At 2004, the first wireless device receives, from the second wireless device based on an expiration of a PDCP discard timer, an indication of a sequence number gap associated with at least one PDU of the plurality of PDUs. For example, FIG. 14 at 1430 shows that the RLC receiver 1402 may receive a discard indication control PDU that includes a SN of a discarded PDU. FIG. 14 also shows that the RLC receiver 1402 may receive the discard indication control PDU based on expiration of a prohibit timer. In an example, the indication of the sequence number gap may be indicated by the DISCARD_SN 1206 of the discard indication control PDU 1200 in FIG. 12 or the DISCARD_SN 1306 of the discard indication control PDU 1300 in FIG. 13. In an example, the at least one PDU may be one of the RLC PDUs 502-506. In yet another example, FIG. 6 illustrates an example of a gap. For example, 2004 may be performed by the PDU discard component 198 or the PDU discard component 199.

At 2006, the first wireless device updates a sliding window of the DRB based on the sequence number gap. For example, FIG. 14 at 1432 shows that the RLC receiver 1402 may advance a receiver sliding window based on the discard indication control PDU. In another example, the RLC receiver 604 in FIG. 6 may update the receiver side sliding window 606. For example, 2006 may be performed by the PDU discard component 198 or the PDU discard component 199. Updating the sliding window may lead to the first wireless device receiving communications in a faster manner, as the first wireless device may not continue to wait to receive a PDU discarded by the second wireless device.

In one aspect, the DRB may be an AM DRB. For example, FIG. 5 illustrates a DRB 514 that may be an AM DRB.

In one aspect, the indication of the sequence number gap may be included in a control PDU. For example, the control PDU may be the discard indication control PDU 1200 or the discard indication control PDU 1300. In an example, the indication of the sequence number gap may be indicated by the DISCARD_SN 1206 or the DISCARD_SN 1306 of FIGS. 12 and 13, respectively.

In one aspect, the control PDU may include: a first field that indicates the control PDU is for control, a second field that indicates the control PDU includes a discard indication, a third field that includes the indication of the sequence number gap, and a fourth field that indicates further discard indications. For example, the first field may be the D/C field 1202, the second field may be the CPT field 1204, the third field may be the DISCARD_SN 1206, and the fourth field may be the E1 field 1210.

In one aspect, the plurality of PDUs may be associated with XR traffic. For example, the plurality of PDUs may be associated with the XR traffic illustrated in FIG. 4.

In one aspect, at 2006A, the first wireless device may maintain a maximum status transmit variable and a receive state variable, and updating the sliding window of the DRB based on the sequence number gap may include the first wireless device updating, if the sequence number gap is equal to a first value of the maximum status transmit variable, the first value of the maximum status transmit variable to be equal to a sequence number of a RLC SDU for which each byte has not been received, where the sequence number is greater than the first value. For example, referring to FIG. 14, advancing the receiver sliding window at 1432 may include updating the first value of the maximum status transmit variable to be equal to a sequence number of a RLC SDU for which each byte has not been received. For example, 2006A may be performed by the PDU discard component 198 or the PDU discard component 199.

In one aspect, at 2006B, the first wireless device may maintain a maximum status transmit variable and a receive state variable, and updating the sliding window of the DRB based on the sequence number gap may include the first wireless device updating, if the sequence gap number is equal to a second value of the receive state variable, the second value of the receive state variable to be equal to the sequence number of the RLC SDU for which each byte has not been received, where the sequence number is greater than the second value. For example, referring to FIG. 14, advancing the receiver sliding window at 1432 may include updating the second value of the receive state variable to be equal to the sequence number of the RLC SDU for which each byte has not been received. For example, 2006B may be performed by the PDU discard component 198 or the PDU discard component 199.

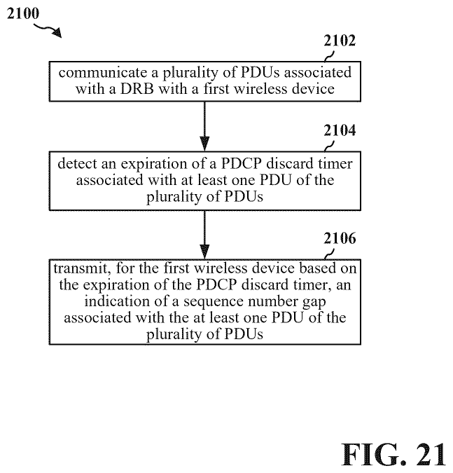

FIG. 21 is a flowchart 2100 of a method of wireless communication at a second wireless device. The method may be performed by a RLC transmitter (e.g., the RLC transmitter 1404). The RLC transmitter may be a UE (e.g., the UE 104, the UE 350, the apparatus 2304). The RLC transmitter may be a network entity (e.g., the base station 102, the CU 110, the DU 130, the RU 140, the base station 310, the network entity 2402). In an example, the method may be performed by the PDU discard component 198 or the PDU discard component 199. The method be associated with increased communications reliability for a UE and/or a network entity.

At 2102, the second wireless device communicates a plurality of PDUs associated with a DRB with a first wireless device. For example, FIG. 14 at 1410 shows that the RLC transmitter 1404 may transmit PDUs to the RLC receiver 1402. In an example, the PDUs may be the RLC PDUs 502-506 associated with the DRB 514 illustrated in FIG. 5. For example, 2102 may be performed by the PDU discard component 198 or the PDU discard component 199.

At 2104, the second wireless device detects an expiration of a PDCP discard timer associated with at least one PDU of the plurality of PDUs. In an example, the at least one PDU may be one of the RLC PDUs 502-506. For example, FIG. 14 at 1429 shows that the RLC transmitter 1404 may detect an expiration of a prohibit timer. For example, 2104 may be performed by the PDU discard component 198 or the PDU discard component 199.

At 2106, the second wireless device transmits, for the first wireless device based on the expiration of the PDCP discard timer, an indication of a sequence number gap associated with the at least one PDU of the plurality of PDUs. For example, FIG. 14 at 1430 shows that the RLC transmitter 1404 may transmit a discard indication control PDU that may include a SN of a discarded PDU. In an example, the indication of the sequence number gap may be indicated by the DISCARD_SN 1206 of the discard indication control PDU 1200 in FIG. 12 or the DISCARD_SN 1306 of the discard indication control PDU 1300 in FIG. 13. In yet another example, FIG. 6 illustrates an example of a gap. For example, 2106 may be performed by the PDU discard component 198 or the PDU discard component 199.

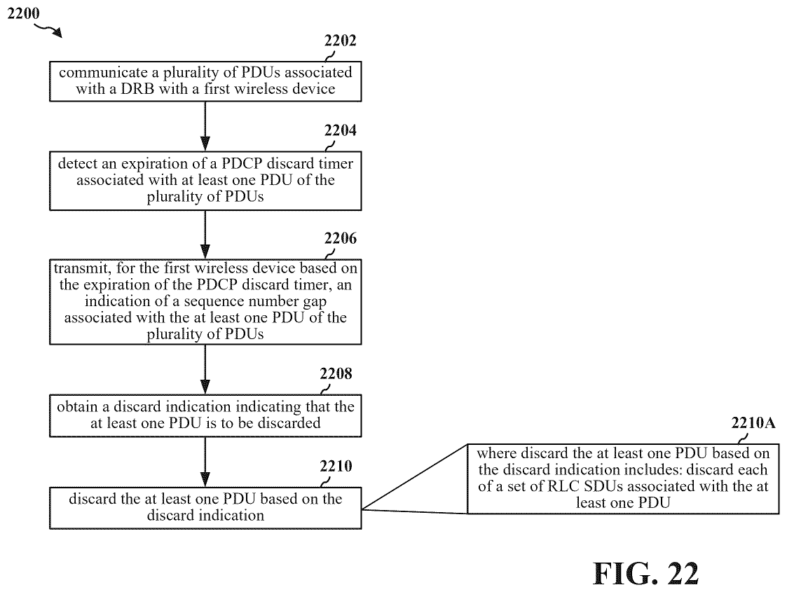

FIG. 22 is a flowchart 2200 of a method of wireless communication at a second wireless device. The method (including the various aspects detailed below) may be performed by a RLC transmitter (e.g., the RLC transmitter 1404). The RLC transmitter may be a UE (e.g., the UE 104, the UE 350, the apparatus 2304). The RLC transmitter may be a network entity (e.g., the base station 102, the CU 110, the DU 130, the RU 140, the base station 310, the network entity 2402). In an example, the method (including the various aspects detailed below) may be performed by the PDU discard component 198 or the PDU discard component 199. The method be associated with increased communications reliability for a UE and/or a network entity.

At 2202, the second wireless device communicates a plurality of PDUs associated with a DRB with a first wireless device. For example, FIG. 14 at 1410 shows that the RLC transmitter 1404 may transmit PDUs to the RLC receiver 1402. In an example, the PDUs may be the RLC PDUs 502-506 associated with the DRB 514 illustrated in FIG. 5. For example, 2202 may be performed by the PDU discard component 198 or the PDU discard component 199.

At 2204, the second wireless device detects an expiration of a PDCP discard timer associated with at least one PDU of the plurality of PDUs. In an example, the at least one PDU may be one of the RLC PDUs 502-506. For example, FIG. 14 at 1429 shows that the RLC transmitter 1404 may detect an expiration of a prohibit timer. For example, 2204 may be performed by the PDU discard component 198 or the PDU discard component 199.

At 2206, the second wireless device transmits, for the first wireless device based on the expiration of the PDCP discard timer, an indication of a sequence number gap associated with the at least one PDU of the plurality of PDUs. For example, FIG. 14 at 1430 shows that the RLC transmitter 1404 may transmit a discard indication control PDU that may include a SN of a discarded PDU. In an example, the indication of the sequence number gap may be indicated by the DISCARD_SN 1206 of the discard indication control PDU 1200 in FIG. 12 or the DISCARD_SN 1306 of the discard indication control PDU 1300 in FIG. 13. In yet another example, FIG. 6 illustrates an example of a gap. For example, 2206 may be performed by the PDU discard component 198 or the PDU discard component 199.

In one aspect, the DRB may be an AM DRB. For example, FIG. 5 illustrates a DRB 514 that may be an AM DRB.

In one aspect, the indication of the sequence number gap may be included in a control PDU. For example, the control PDU may be the discard indication control PDU 1200 or the discard indication control PDU 1300. In an example, the indication of the sequence number gap may be indicated by the DISCARD_SN 1206 or the DISCARD_SN 1306 of FIGS. 12 and 13, respectively.

In one aspect, the control PDU may include: a first field that indicates the control PDU is for control, a second field that indicates the control PDU includes a discard indication, a third field that includes the indication of the sequence number gap, and a fourth field that indicates further discard indications. For example, the first field may be the D/C field 1202, the second field may be the CPT field 1204, the third field may be the DISCARD_SN 1206, and the fourth field may be the E1 field 1210.

In one aspect, at 2208, the second wireless device may obtain a discard indication indicating that the at least one PDU is to be discarded. For example, FIG. 14 at 1426 shows that the RLC transmitter 1404 may obtain a discard indication. For example, 2208 may be performed by the PDU discard component 198 or the PDU discard component 199.

In one aspect at 2210, the second wireless device may discard the at least one PDU based on the discard indication. For example, FIG. 14 at 1428 shows that the RLC transmitter 1404 may discard a PDU based on the discard indication obtained at 1426. For example, 2210 may be performed by the PDU discard component 198 or the PDU discard component 199.

In one aspect, at 2210A, discarding the at least one PDU based on the discard indication may include: discarding each of a set of RLC SDUs associated with the at least one PDU. For example, the set of RLC SDUs may be the RLC SDUs 508-512 illustrated in FIG. 5. For example, 2210A may be performed by the PDU discard component 198 or the PDU discard component 199.

In one aspect, the PDCP discard timer may be initiated when the discard indication is obtained. For example, FIG. 14 shows that the prohibit timer may begin to run when the RLC transmitter 1404 obtains the discard indication at 1426.

In one aspect, where the plurality of PDUs is associated with XR traffic. For example, the plurality of PDUs may be associated with the XR traffic illustrated in FIG. 4.

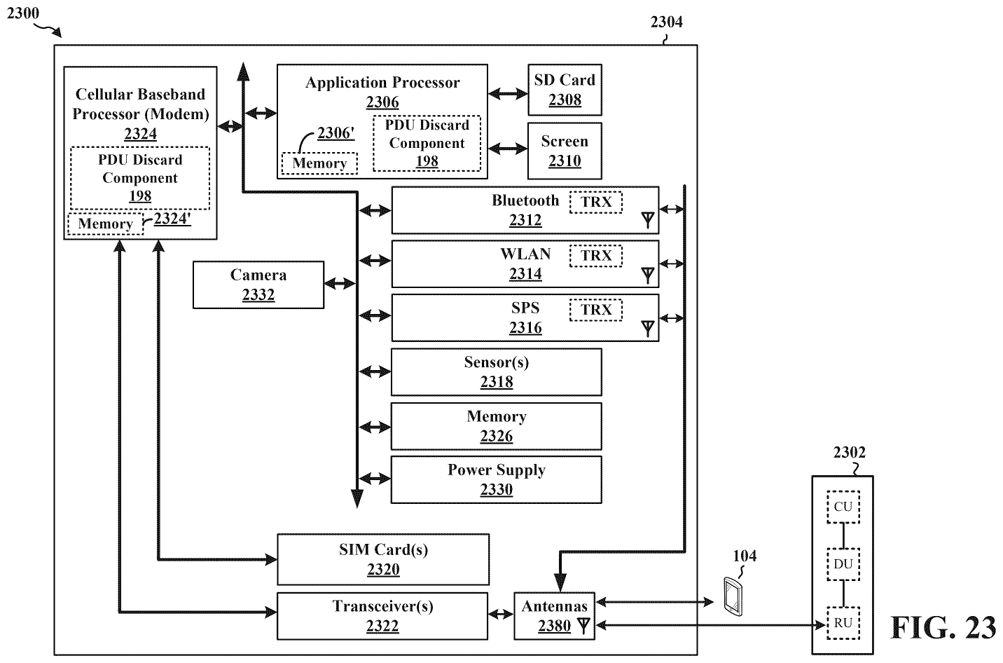

FIG. 23 is a diagram 2300 illustrating an example of a hardware implementation for an apparatus 2304. The apparatus 2304 may be a UE, a component of a UE, or may implement UE functionality. In some aspects, the apparatus 2304 may include a cellular baseband processor 2324 (also referred to as a modem) coupled to one or more transceivers 2322 (e.g., cellular RF transceiver). The cellular baseband processor 2324 may include on-chip memory 2324′. In some aspects, the apparatus 2304 may further include one or more subscriber identity modules (SIM) cards 2320 and an application processor 2306 coupled to a secure digital (SD) card 2308 and a screen 2310. The application processor 2306 may include on-chip memory 2306′. In some aspects, the apparatus 2304 may further include a Bluetooth module 2312, a WLAN module 2314, an SPS module 2316 (e.g., GNSS module), one or more sensor modules 2318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2326, a power supply 2330, and/or a camera 2332. The Bluetooth module 2312, the WLAN module 2314, and the SPS module 2316 may include an on-chip transceiver (TRX) (or in some cases, just a receiver (RX)). The Bluetooth module 2312, the WLAN module 2314, and the SPS module 2316 may include their own dedicated antennas and/or utilize the antennas 2380 for communication. The cellular baseband processor 2324 communicates through the transceiver(s) 2322 via one or more antennas 2380 with the UE 104 and/or with an RU associated with a network entity 2302. The cellular baseband processor 2324 and the application processor 2306 may each include a computer-readable medium/memory 2324′, 2306′, respectively. The additional memory modules 2326 may also be considered a computer-readable medium/memory. Each computer-readable medium/memory 2324′, 2306′, 2326 may be non-transitory. The cellular baseband processor 2324 and the application processor 2306 are each responsible for general processing, including the execution of software stored on the computer-readable medium/memory. The software, when executed by the cellular baseband processor 2324/application processor 2306, causes the cellular baseband processor 2324/application processor 2306 to perform the various functions described supra. The computer-readable medium/memory may also be used for storing data that is manipulated by the cellular baseband processor 2324/application processor 2306 when executing software. The cellular baseband processor 2324/application processor 2306 may be a component of the UE 350 and may include the memory 360 and/or at least one of the TX processor 368, the RX processor 356, and the controller/processor 359. In one configuration, the apparatus 2304 may be a processor chip (modem and/or application) and include just the cellular baseband processor 2324 and/or the application processor 2306, and in another configuration, the apparatus 2304 may be the entire UE (e.g., see 350 of FIG. 3) and include the additional modules of the apparatus 2304.

As discussed supra, the PDU discard component 198 is configured to communicate a plurality of PDUs associated with a DRB with a second wireless device. The PDU discard component 198 is configured to detect that at least one PDU in the plurality of PDUs associated with the DRB meets at least one discard criteria. The PDU discard component 198 is configured to transmit, for the second wireless device, a discard status report associated with the at least one PDU meeting the at least one discard criteria. The PDU discard component 198 is configured to communicate a plurality of PDUs associated with a DRB with a first wireless device. The PDU discard component 198 is configured to receive, from the first wireless device, a discard status report associated with at least one PDU in the plurality of PDUs meeting at least one discard criteria. The PDU discard component 198 is configured to update a sliding window of the DRB based on the discard status report. The PDU discard component 198 is configured to communicate a plurality of PDUs associated with a DRB with a second wireless device. The PDU discard component 198 is configured to receive, from the second wireless device based on an expiration of a PDCP discard timer, an indication of a sequence number gap associated with at least one PDU of the plurality of PDUs. The PDU discard component 198 is configured to update a sliding window of the DRB based on the sequence number gap. The PDU discard component 198 is configured to communicate a plurality of PDUs associated with a DRB with a first wireless device. The PDU discard component 198 is configured to detect an expiration of a PDCP discard timer associated with at least one PDU of the plurality of PDUs. The PDU discard component 198 is configured to transmit, for the first wireless device based on the expiration of the PDCP discard timer, an indication of a sequence number gap associated with the at least one PDU of the plurality of PDUs. The PDU discard component 198 may be within the cellular baseband processor 2324, the application processor 2306, or both the cellular baseband processor 2324 and the application processor 2306. The PDU discard component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2304 may include a variety of components configured for various functions. In one configuration, the apparatus 2304, and in particular the cellular baseband processor 2324 and/or the application processor 2306, includes means for communicating a plurality of PDUs associated with a DRB with a second wireless device. In one configuration, the apparatus 2304, and in particular the cellular baseband processor 2324 and/or the application processor 2306, includes means for detecting that at least one PDU in the plurality of PDUs associated with the DRB meets at least one discard criteria. In one configuration, the apparatus 2304, and in particular the cellular baseband processor 2324 and/or the application processor 2306, includes means for transmitting, for the second wireless device, a discard status report associated with the at least one PDU meeting the at least one discard criteria. In one configuration, the apparatus 2304, and in particular the cellular baseband processor 2324 and/or the application processor 2306, includes means for discarding the at least one PDU upon detecting that the at least one PDU meets the at least one discard criteria. In one configuration, the means for discarding the at least one PDU upon detecting that the at least one PDU meets the at least one discard criteria include means for discarding each of a set of RLC SDUs associated with the at least one PDU. In one configuration, the apparatus 2304, and in particular the cellular baseband processor 2324 and/or the application processor 2306, includes means for receiving a configuration for a status prohibit timer associated with missing PDUs or a status report prohibit timer associated with PDU discards, where the discard status report is associated with the status prohibit timer or the status report prohibit timer. In one configuration, the apparatus 2304, and in particular the cellular baseband processor 2324 and/or the application processor 2306, includes means for communicating a plurality of PDUs associated with a DRB with a first wireless device. In one configuration, the apparatus 2304, and in particular the cellular baseband processor 2324 and/or the application processor 2306, includes means for receiving, from the first wireless device, a discard status report associated with at least one PDU in the plurality of PDUs meeting at least one discard criteria. In one configuration, the apparatus 2304, and in particular the cellular baseband processor 2324 and/or the application processor 2306, includes means for updating a sliding window of the DRB based on the discard status report. In one configuration, the apparatus 2304, and in particular the cellular baseband processor 2324 and/or the application processor 2306, includes means for transmitting a configuration for a status prohibit timer associated with missing PDUs or a status report prohibit timer associated with PDU discards, where the discard status report is associated with the status prohibit timer or the status report prohibit timer. In one configuration, the apparatus 2304, and in particular the cellular baseband processor 2324 and/or the application processor 2306, includes means for sending an indication to a PDCP layer that indicates each of a set of RLC SDUs associated with the at least one PDU has been discarded. In one configuration where the second wireless device maintains an acknowledgment state variable and a send state variable, where a sequence number of a RLC SDU associated with the at least one PDU associated with the discard status report is greater than or equal to a first value of the acknowledgment state variable and less than or equal to a second value of the send state variable, the means for updating the sliding window of the DRB based on the discard status report include means for setting the first value of the acknowledgment state variable to be equal to the sequence number, where the RLC SDU belongs to a set of RLC SDUs for which a positive acknowledgment has not been received by the second wireless device, where the sequence number is less than each sequence number of the set of RLC SDUs. In one configuration, the apparatus 2304, and in particular the cellular baseband processor 2324 and/or the application processor 2306, includes means for communicating a plurality of PDUs associated with a DRB with a second wireless device. In one configuration, the apparatus 2304, and in particular the cellular baseband processor 2324 and/or the application processor 2306, includes means for receiving, from the second wireless device based on an expiration of a PDCP discard timer, an indication of a sequence number gap associated with at least one PDU of the plurality of PDUs. In one configuration, the apparatus 2304, and in particular the cellular baseband processor 2324 and/or the application processor 2306, includes means for updating a sliding window of the DRB based on the sequence number gap. In one configuration where the first wireless device maintains a maximum status transmit variable and a receive state variable, the means for updating the sliding window of the DRB based on the sequence number gap include means for updating, if the sequence number gap is equal to a first value of the maximum status transmit variable, the first value of the maximum status transmit variable to be equal to a sequence number of a RLC SDU for which each byte has not been received, where the sequence number is greater than the first value. In one configuration where the first wireless device maintains a maximum status transmit variable and a receive state variable, the means for updating the sliding window of the DRB based on the sequence number gap include means for updating, if the sequence gap number is equal to a second value of the receive state variable, the second value of the receive state variable to be equal to the sequence number of the RLC SDU for which each byte has not been received, where the sequence number is greater than the second value. In one configuration, the apparatus 2304, and in particular the cellular baseband processor 2324 and/or the application processor 2306, includes means for communicating a plurality of PDUs associated with a DRB with a first wireless device. In one configuration, the apparatus 2304, and in particular the cellular baseband processor 2324 and/or the application processor 2306, includes means for detecting an expiration of a PDCP discard timer associated with at least one PDU of the plurality of PDUs. In one configuration, the apparatus 2304, and in particular the cellular baseband processor 2324 and/or the application processor 2306, includes means for transmitting, for the first wireless device based on the expiration of the PDCP discard timer, an indication of a sequence number gap associated with the at least one PDU of the plurality of PDUs. In one configuration, the apparatus 2304, and in particular the cellular baseband processor 2324 and/or the application processor 2306, includes means for obtaining a discard indication indicating that the at least one PDU is to be discarded. In one configuration, the apparatus 2304, and in particular the cellular baseband processor 2324 and/or the application processor 2306, includes means for discarding the at least one PDU based on the discard indication. In one configuration, the means for discarding the at least one PDU based on the discard indication include means for discarding each of a set of RLC SDUs associated with the at least one PDU. The means may be the PDU discard component 198 of the apparatus 2304 configured to perform the functions recited by the means. As described supra, the apparatus 2304 may include the TX processor 368, the RX processor 356, and the controller/processor 359. As such, in one configuration, the means may be the TX processor 368, the RX processor 356, and/or the controller/processor 359 configured to perform the functions recited by the means.

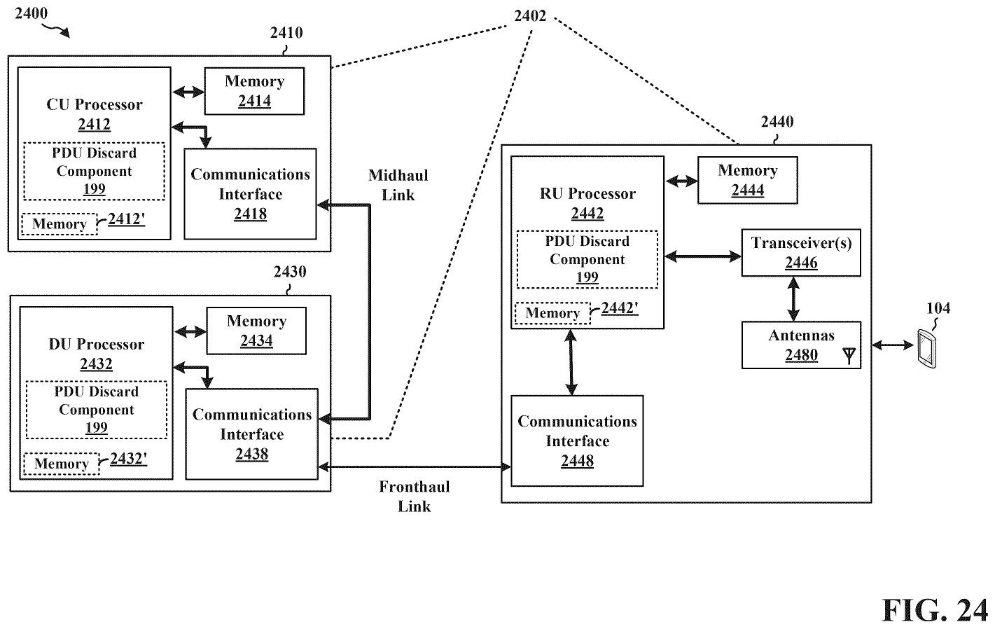

FIG. 24 is a diagram 2400 illustrating an example of a hardware implementation for a network entity 2402. The network entity 2402 may be a BS, a component of a BS, or may implement BS functionality. The network entity 2402 may include at least one of a CU 2410, a DU 2430, or an RU 2440. For example, depending on the layer functionality handled by the PDU discard component 199, the network entity 2402 may include the CU 2410; both the CU 2410 and the DU 2430; each of the CU 2410, the DU 2430, and the RU 2440; the DU 2430; both the DU 2430 and the RU 2440; or the RU 2440. The CU 2410 may include a CU processor 2412. The CU processor 2412 may include on-chip memory 2412′. In some aspects, the CU 2410 may further include additional memory modules 2414 and a communications interface 2418. The CU 2410 communicates with the DU 2430 through a midhaul link, such as an F1 interface. The DU 2430 may include a DU processor 2432. The DU processor 2432 may include on-chip memory 2432′. In some aspects, the DU 2430 may further include additional memory modules 2434 and a communications interface 2438. The DU 2430 communicates with the RU 2440 through a fronthaul link. The RU 2440 may include an RU processor 2442. The RU processor 2442 may include on-chip memory 2442′. In some aspects, the RU 2440 may further include additional memory modules 2444, one or more transceivers 2446, antennas 2480, and a communications interface 2448. The RU 2440 communicates with the UE 104. The on-chip memory 2412′, 2432′, 2442′ and the additional memory modules 2414, 2434, 2444 may each be considered a computer-readable medium/memory. Each computer-readable medium/memory may be non-transitory. Each of the processors 2412, 2432, 2442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the PDU discard component 199 is configured to communicate a plurality of PDUs associated with a DRB with a second wireless device. The PDU discard component 199 is configured to detect that at least one PDU in the plurality of PDUs associated with the DRB meets at least one discard criteria. The PDU discard component 199 is configured to transmit, for the second wireless device, a discard status report associated with the at least one PDU meeting the at least one discard criteria. The PDU discard component 199 is configured to communicate a plurality of PDUs associated with a DRB with a first wireless device. The PDU discard component 199 is configured to receive, from the first wireless device, a discard status report associated with at least one PDU in the plurality of PDUs meeting at least one discard criteria. The PDU discard component 199 is configured to update a sliding window of the DRB based on the discard status report. The PDU discard component 199 is configured to communicate a plurality of PDUs associated with a DRB with a second wireless device. The PDU discard component 199 is configured to receive, from the second wireless device based on an expiration of a PDCP discard timer, an indication of a sequence number gap associated with at least one PDU of the plurality of PDUs. The PDU discard component 199 is configured to update a sliding window of the DRB based on the sequence number gap. The PDU discard component 199 is configured to communicate a plurality of PDUs associated with a DRB with a first wireless device. The PDU discard component 199 is configured to detect an expiration of a PDCP discard timer associated with at least one PDU of the plurality of PDUs. The PDU discard component 199 is configured to transmit, for the first wireless device based on the expiration of the PDCP discard timer, an indication of a sequence number gap associated with the at least one PDU of the plurality of PDUs. The PDU discard component 199 may be within one or more processors of one or more of the CU 2410, DU 2430, and the RU 2440. The PDU discard component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2402 may include a variety of components configured for various functions. In one configuration, the network entity 2402 includes means for communicating a plurality of PDUs associated with a DRB with a second wireless device. In one configuration, the network entity 2402 includes means for detecting that at least one PDU in the plurality of PDUs associated with the DRB meets at least one discard criteria. In one configuration, the network entity 2402 includes means for transmitting, for the second wireless device, a discard status report associated with the at least one PDU meeting the at least one discard criteria. In one configuration, the network entity 2402 includes means for discarding the at least one PDU upon detecting that the at least one PDU meets the at least one discard criteria. In one configuration, the network entity 2402 includes means for discarding the at least one PDU upon detecting that the at least one PDU meets the at least one discard criteria include means for discarding each of a set of RLC SDUs associated with the at least one PDU. In one configuration, the network entity 2402 includes means for receiving a configuration for a status prohibit timer associated with missing PDUs or a status report prohibit timer associated with PDU discards, where the discard status report is associated with the status prohibit timer or the status report prohibit timer. In one configuration, the network entity 2402 includes means for communicating a plurality of PDUs associated with a DRB with a first wireless device. In one configuration, the network entity 2402 includes means for receiving, from the first wireless device, a discard status report associated with at least one PDU in the plurality of PDUs meeting at least one discard criteria. In one configuration, the network entity 2402 includes means for updating a sliding window of the DRB based on the discard status report. In one configuration, the network entity 2402 includes means for transmitting a configuration for a status prohibit timer associated with missing PDUs or a status report prohibit timer associated with PDU discards, where the discard status report is associated with the status prohibit timer or the status report prohibit timer. In one configuration, the network entity 2402 includes means for sending an indication to a PDCP layer that indicates each of a set of RLC SDUs associated with the at least one PDU has been discarded. In one configuration where the second wireless device maintains an acknowledgment state variable and a send state variable, where a sequence number of a RLC SDU associated with the at least one PDU associated with the discard status report is greater than or equal to a first value of the acknowledgment state variable and less than or equal to a second value of the send state variable, the means for updating the sliding window of the DRB based on the discard status report include means for setting the first value of the acknowledgment state variable to be equal to the sequence number, where the RLC SDU belongs to a set of RLC SDUs for which a positive acknowledgment has not been received by the second wireless device, where the sequence number is less than each sequence number of the set of RLC SDUs. In one configuration, the network entity 2402 includes means for communicating a plurality of PDUs associated with a DRB with a second wireless device. In one configuration, the network entity 2402 includes means for receiving, from the second wireless device based on an expiration of a PDCP discard timer, an indication of a sequence number gap associated with at least one PDU of the plurality of PDUs. In one configuration, the network entity 2402 includes means for updating a sliding window of the DRB based on the sequence number gap. In one configuration where the first wireless device maintains a maximum status transmit variable and a receive state variable, the means for updating the sliding window of the DRB based on the sequence number gap include means for updating, if the sequence number gap is equal to a first value of the maximum status transmit variable, the first value of the maximum status transmit variable to be equal to a sequence number of a RLC SDU for which each byte has not been received, where the sequence number is greater than the first value. In one configuration where the first wireless device maintains a maximum status transmit variable and a receive state variable, the means for updating the sliding window of the DRB based on the sequence number gap include means for updating, if the sequence gap number is equal to a second value of the receive state variable, the second value of the receive state variable to be equal to the sequence number of the RLC SDU for which each byte has not been received, where the sequence number is greater than the second value. In one configuration, the network entity 2402 includes means for communicating a plurality of PDUs associated with a DRB with a first wireless device. In one configuration, the network entity 2402 includes means for detecting an expiration of a PDCP discard timer associated with at least one PDU of the plurality of PDUs. In one configuration, the network entity 2402 includes means for transmitting, for the first wireless device based on the expiration of the PDCP discard timer, an indication of a sequence number gap associated with the at least one PDU of the plurality of PDUs. In one configuration, the network entity 2402 includes means for obtaining a discard indication indicating that the at least one PDU is to be discarded. In one configuration, the network entity 2402 includes means for discarding the at least one PDU based on the discard indication. In one configuration, the means for discarding the at least one PDU based on the discard indication include means for discarding each of a set of RLC SDUs associated with the at least one PDU. The means may be the PDU discard component 199 of the network entity 2402 configured to perform the functions recited by the means. As described supra, the network entity 2402 may include the TX processor 316, the RX processor 370, and the controller/processor 375. As such, in one configuration, the means may be the TX processor 316, the RX processor 370, and/or the controller/processor 375 configured to perform the functions recited by the means.

Various types of events may trigger PDU discards in layer 2 (L2) procedures. For example, if a PDU misses a configured delay budget or a signaled delivery deadline, the PDU may become outdated. PDU discard may be triggered by intra-PDU set dependency. In one example, a PDU set may be configured such that each PDU in the PDU set is to be transmitted or received. If a PDU in the PDU set is discarded, other PDUs in the PDU set may also be discarded. In another example, if a PDU in the PDU set is discarded, subsequent PDUs in the PDU set may also be discarded. PDU discard may also be triggered by inter-frame dependency. In an example, there may be a dependency between PDUs in a quality of service (QoS) flow. For instance, decoding predicted picture frames (p-frames) in a video flow may depend on an intra-coded picture frame (I-frame) in the same burst. If a UE discards the I-frame, the UE may also discard associated P-frames as such frames may be obsolete. If an RLC receiver discards a PDU, but does not notify an RLC transmitter of the discard, the RLC transmitter may not advance a transmitter side automatic repeat request (ARQ) window. This may delay further transmissions by the RLC transmitter. If an RLC transmitter discards a PDU, but does not notify an RLC receiver of the discard, there may be a gap in an RLC PDU SN. This may delay advancement of a receiver side ARQ window.

Various technologies pertaining to PDU discard are described herein. In an example, a first wireless device communicates a plurality of PDUs associated with a DRB with a second wireless device. The first wireless device detects that at least one PDU in the plurality of PDUs associated with the DRB meets at least one discard criteria. The first wireless device transmits, for the second wireless device, a discard status report associated with the at least one PDU meeting the at least one discard criteria. The second wireless device may update a sliding window based upon the discard status report. Thus, the discard status reports may prevent a stall in transmissions by the second wireless device and hence may lead to increased communications reliability at the first wireless device. In another example, the first wireless device communicates a plurality of PDUs associated with a DRB with a second wireless device. The first wireless devices receive, from the second wireless device based on an expiration of a PDCP discard timer, an indication of a sequence number gap associated with at least one PDU of the plurality of PDUs. The first wireless device updates a sliding window of the DRB based on the sequence number gap. Thus, the indication of the sequence number gap may aid the first wireless device in updating the sliding window and may lead to increased communications reliability at the first wireless device.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first wireless device, including: communicating a plurality of PDUs associated with a DRB with a second wireless device; detecting that at least one PDU in the plurality of PDUs associated with the DRB meets at least one discard criteria; and transmitting, for the second wireless device, a discard status report associated with the at least one PDU meeting the at least one discard criteria.

Aspect 2 is the method of aspect 1, where the at least one discard criteria includes one or more of: an intra-PDU set dependency, a missed delay deadline, a FEC coding redundancy ratio being above a decoding threshold, or an inter-frame dependency.

Aspect 3 is the method of any of aspects 1-2, further including: discarding the at least one PDU upon detecting that the at least one PDU meets the at least one discard criteria.

Aspect 4 is the method of aspect 3, where discarding the at least one PDU includes: discarding each of a set of RLC SDUs associated with the at least one PDU.

Aspect 5 is the method of any of aspects 1-4, where the DRB is an AM DRB.

Aspect 6 is the method of any of aspects 1-5, further including: receiving a configuration for a status prohibit timer associated with missing PDUs or a status report prohibit timer associated with PDU discards, where the discard status report is associated with the status prohibit timer or the status report prohibit timer.

Aspect 7 is the method of aspect 6, where the discard status report is transmitted at a time that corresponds to an expiration of the status prohibit timer or the status report prohibit timer.

Aspect 8 is the method of any of aspects 1-7, where the discard status report utilizes an acknowledge field to indicate at least one sequence number of the at least one PDU.

Aspect 9 is the method of any of aspects 1-8, where the discard status report includes at least one additional field compared to at least one other discard status report, where the at least one additional field includes at least one sequence number of the at least one PDU.

Aspect 10 is the method of any of aspects 1-9, where the plurality of PDUs is associated with XR traffic.

Aspect 11 is an apparatus for wireless communication at a first wireless device including a memory and at least one processor coupled to the memory and based at least in part on information stored in the memory, the at least one processor is configured to perform a method in accordance with any of aspects 1-10.

Aspect 12 is an apparatus for wireless communications, including means for performing a method in accordance with any of aspects 1-10.

Aspect 13 is the apparatus of aspect 11 or 12 further including at least one of a transceiver or an antenna coupled to the at least one processor, where the at least one processor is configured to transmit the discard status report via at least one of the transceiver or the antenna.

Aspect 14 is a non-transitory computer-readable medium including instructions that, when executed by an apparatus, cause the apparatus to perform a method in accordance with any of aspects 1-10.

Aspect 15 is a method of wireless communication at a second wireless device, including: communicating a plurality of PDUs associated with a DRB with a first wireless device; receiving, from the first wireless device, a discard status report associated with at least one PDU in the plurality of PDUs meeting at least one discard criteria; and updating a sliding window of the DRB based on the discard status report.

Aspect 16 is the method of aspect 15, where the at least one discard criteria includes one or more of: an intra-PDU set dependency, a missed delay deadline, a FEC coding redundancy ratio being above a decoding threshold, or an inter-frame dependency.

Aspect 17 is the method of any of aspects 15-16, where the DRB is an AM DRB.

Aspect 18 is the method of any of aspects 15-17, further including: transmitting a configuration for a status prohibit timer associated with missing PDUs or a status report prohibit timer associated with PDU discards, where the discard status report is associated with the status prohibit timer or the status report prohibit timer.

Aspect 19 is the method of aspect 18, where the discard status report is received at a time that corresponds to an expiration of the status prohibit timer or the status report prohibit timer.

Aspect 20 is the method of any of aspects 15-19, where the discard status report utilizes an acknowledge field to indicate at least one sequence number of the at least one PDU.

Aspect 21 is the method of any of aspects 15-20, where the discard status report includes at least one additional field compared to at least one other discard status report, where the at least one additional field includes at least one sequence number of the at least one PDU.

Aspect 22 is the method of aspect 21, further including: sending an indication to a PDCP layer that indicates each of a set of RLC SDUs associated with the at least one PDU has been discarded.

Aspect 23 is the method of any of aspects 15-22, where the plurality of PDUs is associated with XR traffic.

Aspect 24 is the method of any of aspects 15-23, where the second wireless device maintains an acknowledgment state variable and a send state variable, where a sequence number of a RLC SDU associated with the at least one PDU associated with the discard status report is greater than or equal to a first value of the acknowledgment state variable and less than or equal to a second value of the send state variable, where updating the sliding window of the DRB based on the discard status report includes: setting the first value of the acknowledgment state variable to be equal to the sequence number, where the RLC SDU belongs to a set of RLC SDUs for which a positive acknowledgment has not been received by the second wireless device, where the sequence number is less than each sequence number of the set of RLC SDUs.

Aspect 25 is an apparatus for wireless communication at a second wireless device including a memory and at least one processor coupled to the memory and based at least in part on information stored in the memory, the at least one processor is configured to perform a method in accordance with any of aspects 15-24.

Aspect 26 is an apparatus for wireless communications, including means for performing a method in accordance with any of aspects 15-24.

Aspect 27 is the apparatus of aspect 25 or 26 further including at least one of a transceiver or an antenna coupled to the at least one processor, where the at least one processor is configured to receive the discard status report via at least one of the transceiver or the antenna.

Aspect 28 is a non-transitory computer-readable medium including instructions that, when executed by an apparatus, cause the apparatus to perform a method in accordance with any of aspects 15-24.

Aspect 29 is a method of wireless communication at a first wireless device, including: communicating a plurality of PDUs associated with a DRB with a second wireless device; receiving, from the second wireless device based on an expiration of a PDCP discard timer, an indication of a sequence number gap associated with at least one PDU of the plurality of PDUs; and updating a sliding window of the DRB based on the sequence number gap.

Aspect 30 is the method of aspect 29, where the DRB is an AM DRB.

Aspect 31 is the method of any of aspects 29-30, where the indication of the sequence number gap is included in a control PDU.

Aspect 32 is the method of aspect 31, where the control PDU includes: a first field that indicates the control PDU is for control, a second field that indicates the control PDU includes a discard indication, a third field that includes the indication of the sequence number gap, and a fourth field that indicates further discard indications.

Aspect 33 is the method of any of aspects 29-32, where the plurality of PDUs are associated with XR traffic.

Aspect 34 is the method of any of aspects 29-33, where the first wireless device maintains a maximum status transmit variable and a receive state variable, and where updating the sliding window of the DRB based on the sequence number gap includes: updating, if the sequence number gap is equal to a first value of the maximum status transmit variable, the first value of the maximum status transmit variable to be equal to a sequence number of a RLC SDU for which each byte has not been received, where the sequence number is greater than the first value; or updating, if the sequence gap number is equal to a second value of the receive state variable, the second value of the receive state variable to be equal to the sequence number of the RLC SDU for which each byte has not been received, where the sequence number is greater than the second value.

Aspect 35 is an apparatus for wireless communication at a first wireless device including a memory and at least one processor coupled to the memory and based at least in part on information stored in the memory, the at least one processor is configured to perform a method in accordance with any of aspects 29-34.

Aspect 36 is an apparatus for wireless communications, including means for performing a method in accordance with any of aspects 29-34.

Aspect 37 is the apparatus of aspect 35 or 36 further including at least one of a transceiver or an antenna coupled to the at least one processor, where the at least one processor is configured to receive the indication of the sequence number gap via at least one of the transceiver or the antenna.

Aspect 38 is a non-transitory computer-readable medium including instructions that, when executed by an apparatus, cause the apparatus to perform a method in accordance with any of aspects 29-34.

Aspect 39 is a method of wireless communication at a second wireless device, including: communicating a plurality of PDUs associated with a DRB with a first wireless device; detecting an expiration of a PDCP discard timer associated with at least one PDU of the plurality of PDUs; and transmitting, for the first wireless device based on the expiration of the PDCP discard timer, an indication of a sequence number gap associated with the at least one PDU of the plurality of PDUs.

Aspect 40 is the method of aspect 39, where the DRB is an AM DRB.

Aspect 41 is the method of any of aspects 39-40, where the indication of the sequence number gap is included in a control PDU.

Aspect 42 is the method of aspect 41, where the control PDU includes: a first field that indicates the control PDU is for control, a second field that indicates the control PDU includes a discard indication, a third field that includes the indication of the sequence number gap, and a fourth field that indicates further discard indications.

Aspect 43 is the method of any of aspects 39-42, further including: obtaining a discard indication indicating that the at least one PDU is to be discarded; and discarding the at least one PDU based on the discard indication.

Aspect 44 is the method of aspect 43, where discarding the at least one PDU based on the discard indication includes: discarding each of a set of RLC SDUs associated with the at least one PDU.

Aspect 45 is the method of aspect 43, where the PDCP discard timer is initiated when the discard indication is obtained.

Aspect 46 is the method of any of aspects 39-45, where the plurality of PDUs is associated with XR traffic.

Aspect 47 is an apparatus for wireless communication at a second wireless device including a memory and at least one processor coupled to the memory and based at least in part on information stored in the memory, the at least one processor is configured to perform a method in accordance with any of aspects 39-46.

Aspect 48 is an apparatus for wireless communications, including means for performing a method in accordance with any of aspects 39-46.

Aspect 49 is the apparatus of aspect 47 or 48 further including at least one of a transceiver or an antenna coupled to the at least one processor, where the at least one processor is configured to transmit the indication of the sequence number gap via at least one of the transceiver or the antenna.

Aspect 50 is a non-transitory computer-readable medium including instructions that, when executed by an apparatus, cause the apparatus to perform a method in accordance with any of aspects 39-46.

1. An apparatus for wireless communication at a first wireless device, comprising:
a memory; and
at least one processor coupled to the memory and, based at least in part on information stored in the memory, the at least one processor is configured to:
communicate a plurality of protocol data units (PDUs) associated with a data radio bearer (DRB) with a second wireless device;
detect that at least one PDU in the plurality of PDUs associated with the DRB meets at least one discard criteria; and
transmit, for the second wireless device, a discard status report associated with the at least one PDU meeting the at least one discard criteria.

2. The apparatus of claim 1, wherein the at least one discard criteria includes one or more of: an intra-PDU set dependency, a missed delay deadline, a flow error correction (FEC) coding redundancy ratio being above a decoding threshold, or an inter-frame dependency.

3. The apparatus of claim 1, wherein the at least one processor is further configured to:
discard the at least one PDU upon detecting that the at least one PDU meets the at least one discard criteria.

4. The apparatus of claim 3, wherein to discard the at least one PDU, the at least one processor is further configured to:
discard each of a set of radio link control (RLC) service data units (SDUs) associated with the at least one PDU.

5. The apparatus of claim 1, wherein the DRB is an acknowledged mode (AM) DRB.

6. The apparatus of claim 1, wherein the at least one processor is further configured to:
receive a configuration for a status prohibit timer associated with missing PDUs or a status report prohibit timer associated with PDU discards, wherein the discard status report is associated with the status prohibit timer or the status report prohibit timer.

7. The apparatus of claim 6, wherein the discard status report is transmitted at a time that corresponds to an expiration of the status prohibit timer or the status report prohibit timer.

8. The apparatus of claim 1, wherein the discard status report utilizes an acknowledge field to indicate at least one sequence number of the at least one PDU.

9. The apparatus of claim 1, wherein the discard status report includes at least one additional field compared to at least one other discard status report, wherein the at least one additional field includes at least one sequence number of the at least one PDU.

10. The apparatus of claim 1, further comprising at least one of a transceiver or an antenna coupled to the at least one processor, wherein the at least one processor is configured to transmit the discard status report via at least one of the transceiver or the antenna.

11. An apparatus for wireless communication at a second wireless device, comprising:
a memory; and
at least one processor coupled to the memory and, based at least in part on information stored in the memory, the at least one processor is configured to:
communicate a plurality of protocol data units (PDUs) associated with a data radio bearer (DRB) with a first wireless device;
receive, from the first wireless device, a discard status report associated with at least one PDU in the plurality of PDUs meeting at least one discard criteria; and
update a sliding window of the DRB based on the discard status report.

12. The apparatus of claim 11, wherein the at least one processor is further configured to:
send an indication to a packet data convergence protocol (PDCP) layer that indicates each of a set of radio link control (RLC) service data units (SDUs) associated with the at least one PDU has been discarded.

13. The apparatus of claim 11, wherein the plurality of PDUs is associated with extended reality (XR) traffic.

14. The apparatus of claim 11, wherein the second wireless device maintains an acknowledgment state variable and a send state variable, wherein a sequence number of a radio link control (RLC) service data unit (SDU) associated with the at least one PDU associated with the discard status report is greater than or equal to a first value of the acknowledgment state variable and less than or equal to a second value of the send state variable, wherein to update the sliding window of the DRB based on the discard status report, the at least one processor is configured to:
set the first value of the acknowledgment state variable to be equal to the sequence number, wherein the RLC SDU belongs to a set of RLC SDUs for which a positive acknowledgment has not been received by the second wireless device, wherein the sequence number is less than each sequence number of the set of RLC SDUs.

15. The apparatus of claim 11, further comprising at least one of a transceiver or an antenna coupled to the at least one processor, wherein the at least one processor is configured to receive the discard status report via at least one of the transceiver or the antenna.

16. An apparatus for wireless communication at a first wireless device, comprising:
a memory; and
at least one processor coupled to the memory and, based at least in part on information stored in the memory, the at least one processor is configured to:
communicate a plurality of protocol data units (PDUs) associated with a data radio bearer (DRB) with a second wireless device;
receive, from the second wireless device based on an expiration of a packet data convergence protocol (PDCP) discard timer, an indication of a sequence number gap associated with at least one PDU of the plurality of PDUs; and
update a sliding window of the DRB based on the sequence number gap.

17. The apparatus of claim 16, wherein the DRB is an acknowledged mode (AM) DRB.

18. The apparatus of claim 16, wherein the indication of the sequence number gap is included in a control PDU.

19. The apparatus of claim 18, wherein the control PDU includes:
a first field that indicates the control PDU is for control,
a second field that indicates the control PDU includes a discard indication,
a third field that includes the indication of the sequence number gap, and
a fourth field that indicates further discard indications.

20. The apparatus of claim 16, wherein the plurality of PDUs is associated with extended reality (XR) traffic.

21-30. (canceled)
